(19) United States
(12) Patent Application Publication
(10) Pub. No.: US 2025/0237131 A1
(43) Pub. Date: Jul. 24, 2025

(54) SYSTEMS AND METHODS FOR PREDICTING HYDRAULIC FRACTURING DESIGN PARMATERS BASED ON INJECTION TEST DATA AND MACHINE LEARNING

(71) Applicant: Schlumberger Technology Corporation, Sugar Land, TX (US)

(72) Inventors: Abdul Muqtadir Khan, Stafford, TX (US); Turki Alqarni, Riyadh (SA)

(21) Appl. No.: 18/699,049

(22) PCT Filed: Oct. 5, 2022
(86) PCT No.: PCT/US2022/045760

§ 371 Date: Apr. 5, 2024

Related U.S. Application Data
(60) Provisional application No. 63/252,428, filed on Oct. 5, 2021.

(51) Int. Cl. E21B 43/267; E21B 49/00

(52) U.S. Cl. CPC E21B 43/267; E21B 49/008; E21B 2200/20; E21B 2200/22

(57) ABSTRACT

Systems and methods presented herein include systems and methods for receiving data relating to an injection/falloff test performed in a well in fluid communication with a subterranean reservoir; determining operational parameters of a hydraulic fracturing operation using at least a portion of the data; applying the operational parameters to a pre-trained machine learning predictive model to determine an optimal set of control parameters; and issuing one or more commands relating to the control parameters to optimize the hydraulic fracturing operation on the subterranean reservoir.

### CROSS-REFERENCE TO RELATED APPLICATION

This application claims priority to and the benefit of U.S. Provisional Patent Application Ser. No. 63/252,428, entitled “Systems and Methods for Predicting Hydraulic Fracturing Design Parameters Based on Injection Test Data and Machine Learning,” filed Oct. 5, 2021, which is hereby incorporated by reference in its entirety for all purposes.

### BACKGROUND

The present disclosure relates to systems and methods for predicting hydraulic fracturing design parameters based on injection test data and machine learning.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

A field operation can include fracturing of a formation, which can be, for example, a reservoir. As an example, a fracturing operation may be referred to as a fracturing job. Hydraulic fracturing (e.g., a stimulation treatment) may be performed on oil and gas wells in low-permeability reservoirs. For example, engineered fluids (e.g., including chemicals such as surfactants, polymers, polymeric surfactants, etc.) can be pumped at high pressure and rate into a reservoir interval to be treated where fracture generation and/or reopening occurs. As an example, wings of a fracture can extend away from a wellbore in opposing directions, for example, according to the natural stresses within the formation. An operation can utilize proppant, such as grains of sand of a particular size, mixed with treatment fluid to keep the fracture open when the treatment is complete. Hydraulic fracturing can aim to create high-permeability communication with a large area of formation.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes receiving data relating to an injection/falloff test performed in a well in fluid communication with a subterranean reservoir; determining operational parameters of a hydraulic fracturing operation using at least a portion of the data; applying the operational parameters to a pre-trained machine learning predictive model to determine an optimal set of control parameters; and issuing one or more commands relating to the control parameters to optimize the hydraulic fracturing operation on the subterranean reservoir.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates an example of a geologic environment and an example of an acquisition technique to acquire seismic data, in accordance with embodiments of the present disclosure;

FIG. 2 illustrates an example of a method that includes various actions associated with hydraulic fracturing modeling and various actions associated with microseismic data acquisition, in accordance with embodiments of the present disclosure;

FIG. 3 illustrates an example of a geologic environment that includes monitoring equipment, a pump, equipment, a seismic sensor or receiver array, and a remote facility, in accordance with embodiments of the present disclosure;

FIGS. 4 and 5 illustrate an example of a method that includes generating fractures, in accordance with embodiments of the present disclosure;

FIG. 6 illustrates an example of a microseismic survey, which may be considered to be a method that utilizes equipment for sensing elastic wave emissions of microseismic events, in accordance with embodiments of the present disclosure;

FIG. 7 illustrates an example of a system that includes water tankers, a precision continuous mixer (PCM), one or more sand chiefs, an optional acid and/or other chemical supply, a blender, a missile manifold, and a fleet of pump systems, in accordance with embodiments of the present disclosure;

FIG. 8 illustrates another example of a system that includes various pumps (e.g., pump systems), in accordance with embodiments of the present disclosure;

FIG. 9 illustrates an example of a workflow that can be utilized for fracture treatment design (e.g., or redesign), in accordance with embodiments of the present disclosure;

FIG. 10 illustrates an example workflow for a vertical well or other single stage well and an example workflow for a horizontal well or other multi-stage well, in accordance with embodiments of the present disclosure;

FIG. 11 illustrates an example of a workflow where a redesign process includes reservoir parameter determinations using an injection test, a data fracturing analysis process, and a redesign meeting prior to a main treatment (main fracturing job), in accordance with embodiments of the present disclosure;

FIG. 12 illustrates an example of a workflow where injection test parameters are input to a machine learning predictive model that can output fluid efficiency data (e.g., percentage) that can be utilized to determine pad data (e.g., percentage), in accordance with embodiments of the present disclosure;

FIG. 13 illustrates an example of a workflow where a main fracture treatment can be performed within a 24-hour period along with an injection test, in accordance with embodiments of the present disclosure;

FIG. 14 illustrates an example table that includes regression, residual and total data, where F-statistics (e.g., F values) are indicated, along with an “F critical” value, in accordance with embodiments of the present disclosure;

FIG. 15 illustrates an example of a method that can be utilized for assessing various model inputs, in accordance with embodiments of the present disclosure;

FIG. 16 illustrates an example of a method that includes a reception block, a determination block, and an issuance block, in accordance with embodiments of the present disclosure;

FIG. 17 illustrates components of an example of a computing system and an example of a networked system, in accordance with embodiments of the present disclosure;

FIG. 18 illustrates an example workflow of proppant fracturing treatment operations, in accordance with embodiments of the present disclosure;

FIG. 19 illustrates a machine learning enabled technical and operational workflow, in accordance with embodiments of the present disclosure;

FIG. 20 illustrates a graph of economic optimization parameter (i.e., the net present value, NPV) versus fracturing treatment design, in accordance with embodiments of the present disclosure;

FIG. 21 illustrates an example an exploratory and confirmatory data analysis framework, in accordance with embodiments of the present disclosure;

FIG. 22 illustrates a workflow for developing the machine learning models, in accordance with embodiments of the present disclosure;

FIG. 23 illustrates a preprocessing I/O parameter correlation matrix, in accordance with embodiments of the present disclosure;

FIG. 24 illustrates a predictive model workflow for digital database construction and machine learning implementation to predict fracturing design treatment parameters, in accordance with embodiments of the present disclosure;

FIG. 25 illustrates a description of a confusion matrix, in accordance with embodiments of the present disclosure;

FIG. 26 illustrates a confusion matrix (top table) and performance metrics (bottom table) for a fluid efficiency output parameter using the XGBoost model, in accordance with embodiments of the present disclosure;

FIG. 27 is a summary of results with all models and classification sensitivity, in accordance with embodiments of the present disclosure;

FIG. 28 is a summary of results with all models and classification sensitivity specifically related to total proppant amount and maximum proppant concentration, in accordance with embodiments of the present disclosure;

FIG. 29 illustrates the machine learning predictive model design and validation workflow, in accordance with embodiments of the present disclosure; and

FIG. 30 illustrates a comparative fracture geometry from outputs of a machine learning predictive model prediction fracture geometry and a net pressure match fracture geometry, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole,” “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface. In addition, as used herein, the terms “proximal” and “distal” may be used to refer to components that are closer to and further away from, respectively, other components being described.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a gas emission analysis system (i.e., solely by the gas emission analysis system, without human intervention).

Various field operations can include controllable equipment. For example, a controller can be operatively coupled to one or more pieces of equipment to control one or more actions thereof. As an example, a controller can provide for control of pumping equipment and, for example, measurement equipment, which can include one or more sensors.

As to pumping fluid, hydraulic fracturing operations can include pumping fluid into a borehole in a formation to generate fractures in the formation. Such pumping can utilize a pump driven by an internal combustion engine where a drive shaft of the internal combustion engine can be operatively coupled to a transmission, which can include various gears that can gear-up or gear-down rotational speed of the drive shaft of the internal combustion engine in a manner that aims to effectively control a pump shaft to achieve one or more desirable pumping parameters (e.g., pump pressure, pump flow rate, etc.). While a single pump is mentioned, a field operation can involve a fleet of pumps where each pump may be mounted on a trailer along with an internal combustion engine and a transmission. A fleet operation can pump fluid to a manifold or manifolds, mixing equipment, etc. A fleet can include homogenous equipment or heterogeneous equipment. For example, a fleet can include a plurality of trailers that include equipment with common specifications or with at least some differing specifications. Further, even where equipment has common specifications, there can be differences in history and/or manufactured specifications from unit to unit, system to system, etc. In some instances, each pump system in a fleet may differ and possess its own characteristics, peculiarities, behaviors, etc. Such a fleet can make unified control problematic, which can result in suboptimal pumping, suboptimal hydraulic fracture generation, suboptimal equipment usage, etc. As described herein, controller optimization via reinforcement learning can be utilized to generate an optimized controller that can be utilized to control a fleet.

Fracturing design in conventional reservoirs typically involves multiple critical diagnostic pumping and analysis to derive treatment parameters. The process is used to characterize and optimize the fracturing treatment. The process including operations, analysis, review, compilation of offset area experience, etc., and can take multiple days. The embodiments described herein utilize a machine learning predictive model (e.g., or sets of machine learning predictive algorithms) where an existing database can be utilized with simple inputs such as an injection/falloff decline transient analysis to predict the treatment parameters. In particular, the embodiments described herein relate to machine learning based workflows utilizing injection test, step rate test, calibration injection, calibration decline data for training and predicting fracture treatment parameters.

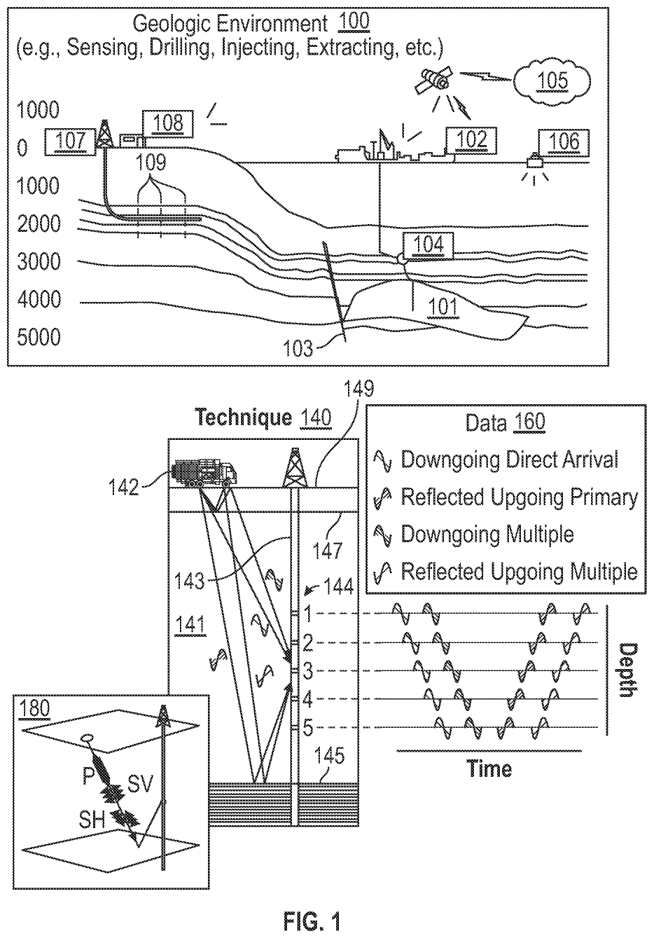

FIG. 1 illustrates an example of a geologic environment 100 (e.g., an environment that includes a sedimentary basin, a reservoir 101, a fault 103, one or more fractures 109, etc.) and an example of an acquisition technique 140 to acquire seismic data. As an example, a system may process data acquired by the technique 140, for example, to allow for direct or indirect management of sensing, drilling, injecting, extracting, etc., with respect to the geologic environment 100. In turn, further information about the geologic environment 100 may become available as feedback (e.g., optionally as input to the system). As an example, an operation may pertain to a reservoir that exists in the geologic environment 100 such as, for example, the reservoir 101. As an example, a technique may provide information (e.g., as an output) that may specify one or more location coordinates of a feature in a geologic environment, one or more characteristics of a feature in a geologic environment, etc.

As an example, a system may include features of a simulation framework such as the PETREL seismic to simulation software framework (Schlumberger Limited, Houston, Texas). The PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. For example, a framework environment marketed as the OCEAN framework environment (Schlumberger Limited, Houston, Texas) allows for integration of add-ons (or plug-ins) into a PETREL framework workflow. The OCEAN framework environment leverages .NET tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

As an example, a framework may be implemented within or in a manner operatively coupled to the DELFI cognitive exploration and production (E&P) environment (Schlumberger Limited, Houston, Texas), which is a secure, cognitive, cloud-based collaborative environment that integrates data and workflows with digital technologies, such as artificial intelligence and machine learning. As an example, such an environment can provide for operations that involve one or more computational frameworks. For example, various types of computational frameworks may be utilized within an environment such as a drilling plan framework, a seismic-to-simulation framework (e.g., PETREL framework, Schlumberger Limited, Houston, Texas), a measurements framework (e.g., TECHLOG framework, Schlumberger Limited, Houston, Texas), a mechanical earth modeling (MEM) framework (PETROMOD framework, Schlumberger Limited, Houston, Texas), an exploration risk, resource, and value assessment framework (e.g., GEOX, Schlumberger Limited, Houston, Texas), a reservoir simulation framework (INTERSECT, Schlumberger Limited, Houston, Texas), a surface facilities framework (e.g., PIPESIM, Schlumberger Limited, Houston, Texas), a stimulation framework (MANGROVE framework, Schlumberger Limited, Houston, Texas). As an example, one or more methods may be implemented at least in part via a framework (e.g., a computational framework) and/or an environment (e.g., a computational environment).

In the example of FIG. 1, the geologic environment 100 may include layers (e.g., stratification) that include the reservoir 101 and that may be intersected by a fault 103 (see also, e.g., the one or more fractures 109, which may intersect a reservoir). As an example, a geologic environment may be or include an offshore geologic environment, a seabed geologic environment, an ocean bed geologic environment, etc.

As an example, the geologic environment 100 may be outfitted with any of a variety of sensors, detectors, actuators, etc. For example, equipment 102 may include communication circuitry to receive and to transmit information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 105 that may be configured for communications, noting that the satellite may additionally or alternatively include circuitry for imagery (e.g., spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109. For example, in certain embodiments, a well in a shale formation may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc., to develop the reservoir (e.g., via fracturing, injecting, extracting, etc.). As an example, the equipment 107 and/or 108 may include components, a system, systems, etc., for fracturing, seismic sensing, analysis of seismic data, assessment of one or more fractures, etc.

As an example, a system may be used to perform one or more workflows. A workflow may be a process that includes a number of work steps. A work step may operate on data, for example, to create new data, to update existing data, etc. As an example, a system may operate on one or more inputs and create one or more results, for example, based on one or more algorithms. As an example, a system may include a workflow editor for creation, editing, executing, etc., of a workflow. In such an example, the workflow editor may provide for selection of one or more pre-defined work steps, one or more customized work steps, etc. As an example, a workflow may be a workflow implementable in the PETREL software, for example, that operates on seismic data, seismic attribute(s), etc. As an example, a workflow may be a process implementable in the OCEAN framework. As an example, a workflow may be a process implementable in the DELFI framework. As an example, a workflow may include one or more work steps that access a module such as a plug-in (e.g., external executable code, etc.). As an example, a workflow may include rendering information to a display (e.g., a display device). As an example, a workflow may include receiving instructions to interact with rendered information, for example, to process information and optionally render processed information. As an example, a workflow may include transmitting information that may control, adjust, initiate, etc. one or more operations of equipment associated with a geologic environment (e.g., in the environment, above the environment, etc.).

In FIG. 1, the technique 140 may be implemented with respect to a geologic environment 141. As shown, an energy source (e.g., a transmitter) 142 (e.g., located at the surface) may emit energy where the energy travels as waves that interact with the geologic environment 141. As an example, the geologic environment 141 may include a bore 143 where one or more sensors (e.g., receivers) 144 may be positioned in the bore 143. As an example, energy emitted by the energy source 142 may interact with a layer (e.g., a structure, an interface, etc.) 145 in the geologic environment 141 such that a portion of the energy is reflected, which may then be sensed by one or more of the sensors 144. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 141 is shown as including a layer 147 that resides below a surface layer 149. Given such an environment and arrangement of the source 142 and the one or more sensors 144, energy may be sensed as being associated with particular types of waves.

As an example, a “multiple” may refer to multiple reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 1, acquired data 160 can include data associated with downgoing direct arrival waves, reflected upgoing primary waves, downgoing multiple reflected waves and reflected upgoing multiple reflected waves. The acquired data 160 is also shown along a time axis and a depth axis. As indicated, in a manner dependent at least in part on characteristics of media in the geologic environment 141, waves travel at velocities over distances such that relationships may exist between time and space. Thus, time information, as associated with sensed energy, may allow for understanding spatial relations of layers, interfaces, structures, etc. in a geologic environment.

FIG. 1 also shows various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by cross-plotting P-wave and S-wave velocities, and/or by other techniques.

As an example, seismic data may be acquired for a region in the form of traces. In the example of FIG. 1, the technique 140 may include the source 142 for emitting energy where portions of such energy (e.g., directly and/or reflected) may be received via the one or more sensors 144. As an example, energy received may be discretized by an analog-to-digital converter that operates at a sampling rate. For example, acquisition equipment may convert energy signals sensed by a sensor to digital samples at a rate of one sample per approximately 4 milliseconds (ms). Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

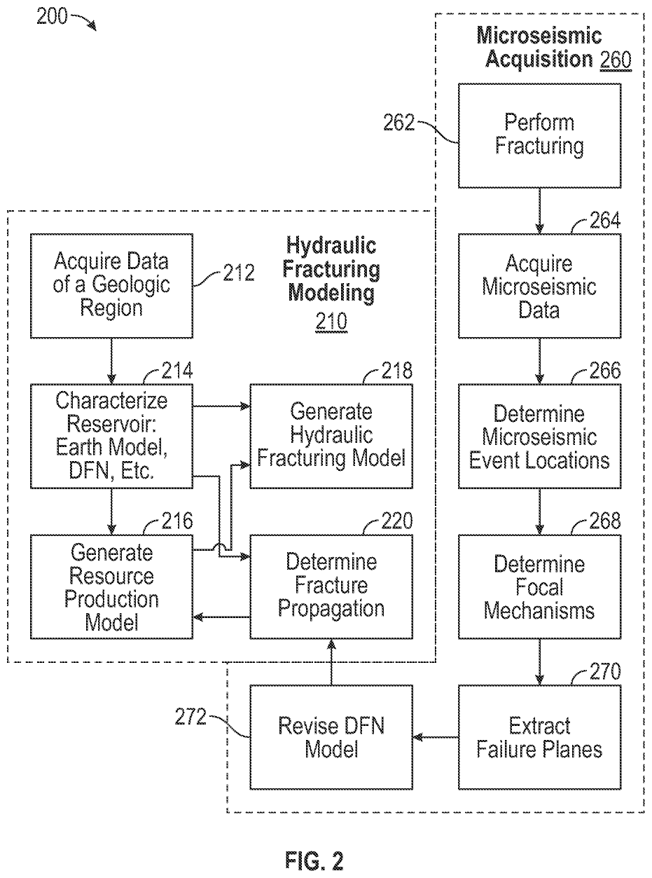

FIG. 2 illustrates an example of a method 200 that includes various actions associated with hydraulic fracturing modeling 210 and various actions associated with microseismic data acquisition 260. As shown, the method 200 includes an acquisition block 212 for acquiring data of a geologic region, a characterization block 214 for characterizing a reservoir in the geologic region via a 3D earth model and a discrete fracture network (DFN) and optionally one or more other actions, a generation block 216 for generating a resource production model of the geologic region, a generation block 218 for generating a hydraulic fracturing model and a determination block 220 for determining information associated with fracture propagation in the geologic region. As shown, the method 200 includes a performance block 262 for performing hydraulic fracturing in the geologic region, an acquisition block 264 for acquiring microseismic data responsive to generation and/or reactivation of fractures in the geologic region, a determination block 266 for determining microseismic event locations in the geologic region, a determination block 268 for determining one or more focal mechanisms based at least in part on the microseismic event locations, an extraction block 270 for extracting one or more failure planes based at least in part on the determined one or more focal mechanisms in the geologic region, a revision block 272 for revising the DFN model that characterizes the reservoir where, as shown, the revised DFN model can be utilized to inform the determination block 220 as to fracture propagation in the geologic region noting that one or more loops can exist within the method 200 that can be performed responsive to fracturing and data acquisition, which can inform, for example, one or more operations in the geologic region (e.g., further fracturing, further data acquisition, production, etc.).

Mechanical earth models (e.g., “MEMs”, 3D earth models, etc.) can be generated from a variety of geologic, petrophysical, geomechanical, and geophysical information, which characterizes complexity and heterogeneity of a reservoir and completion properties in one or more formations of interest (see, e.g., the block 214). As an example, data can be acquired via one or more of 3D seismic surveys, acoustic impedance and other seismic-derived property volumes (e.g., bulk modulus, Poisson's ratio, etc.), microseismic surveys, sonic logs, rock cores, burial history, petrophysical measurements from well logs, etc. (see, e.g., the block 212). As an example, natural fracture patterns and regional stress field may be mapped using such multi-domain, multi-scale information as borehole images and 2D and 3D seismic surveys, which can then be used to develop and calibrate fracture propagation models (see, e.g., the block 220). As an example, a mechanical earth model may be used to generate maps to asses, perform, etc., one or more of drilling, fracturing, and operational risks. As described with respect to FIG. 2, the method 200 can include integrating hydraulic fracturing models (see, e.g., the block 218) developed through integration of geologic and structural models with production simulation models and risk maps (see, e.g., the block 216), which can provide for decision making for completion operations, execution of an optimum stimulation plan, etc.

As an example, hydraulic fracturing models developed through the integration of geologic and structural reservoir characterization models, fracture propagation models and production models may be utilized in evaluating different unconventional completion operations. For example, consider operations that include real-time microseismic data acquisition for evaluating performance of hydraulic fracturing stimulations and in providing information about for calibrating and developing revised fracture models for one or more of ongoing and future stimulations.

Microseismic monitoring provides a valuable tool to evaluate hydraulic fracture treatments in real-time and can be utilized in planning and managing reservoir development. Microseismic event locations, source characteristics and attributes can provide estimates of hydraulic fracturing geometry that can be evaluated with respect to a completion plan and expected fracture growth. Microseismic event derived attributes such as fracture azimuth, height and length, location and complexity, may be utilized to determine the extent of fracture coverage of the reservoir target and effective stimulated volume, as well as in diagnosing under-stimulated sections of the reservoir and in planning re-stimulation of under-producing perforations and wells. Microseismic event locations can also help to avoid hazards during stimulation (e.g. faults, karst, aquifers, etc.). As an example, a method can include modifications to one or more treatment plans and operations based at least in part on microseismic interpretations.

As an example, microseismic monitoring results may be used in updating and calibrating geologic and structural models used in planning completions. Information about the inelastic deformation of the fracture source (fracture plane orientation and slip) that generates the microseismic signal may be, for example, obtained through moment tensor inversion. The moment tensor can describe various source types (e.g. explosion, tensile crack opening or closing, slip on a plane or a combination thereof). As hydraulic fracture microseismicity can be a result of high-pressure injection of fluids and proppant to open fracture paths, moment tensor inversion can be used to determine fracture opening and closing events from shear displacements, providing valuable information to engineers as to whether their fractures pathways are open or closed. Moment tensors may also provide a direct measurement of the local stress-strain regime, fracture orientations, and changes to the local stresses and fracture orientation through time that can be used to develop and calibrate discrete fracture network (DFN) models.

Integrated workflows leveraging multi-scale, multi-domain measurements and microseismic interpretation enables optimization of hydraulic fracturing treatment for increased production. These integrated completions planning workflows may use a wide variety of information about the geology (e.g., lithology, stress contrast, natural fracturing, structural or depositional dip, faulting), and the associated rock properties (e.g., noise, slowness, anisotropy, attenuation) to improve hydraulic fracturing operations to lead to improved hydraulic fracture stimulations, completion plans, and well placement and, thereby, improved production. As an example, microseismic event locations and attributes may be integrated and compared with treatment pressure records, proppant concentration, and injection rate to better perform field operations.

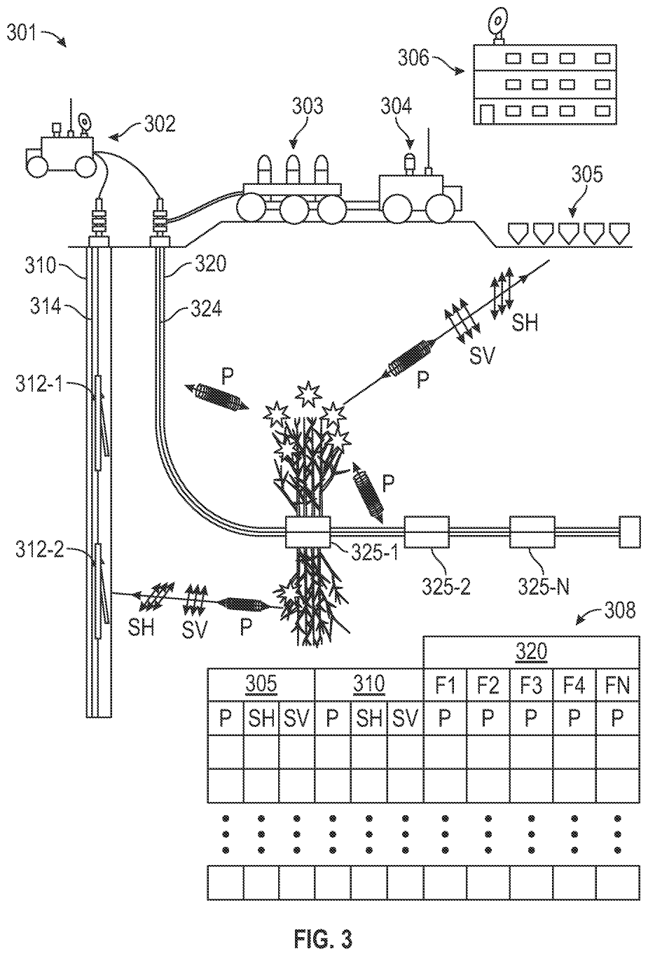

FIG. 3 illustrates an example of a geologic environment 301 that includes monitoring equipment 302, a pump 303, equipment 304, a seismic sensor or receiver array 305, and a remote facility 306. As shown, various types of communication may be implemented such that one or more pieces of equipment can communicate with one or more other pieces of equipment. As an example, equipment can include geopositioning equipment (e.g., GPS, etc.). As an example, equipment can include one or more satellites and one or more satellite links (e.g., dishes, antennas, etc.).

In the example of FIG. 3, a monitoring well 310 and a treatment well 320 are disposed in the geologic environment 301. The monitoring well 310 includes a plurality of sensors 312-1 and 312-2 and optionally a fiber cable sensor 314 and the treatment well 320 optionally includes a fiber cable sensor 324 and one or more sets of perforations 325-1, 325-2, 325-N (e.g., as generated by perforating equipment, which may utilize force generated via one or more mechanisms).

Equipment in the example of FIG. 3 can be utilized to perform one or more methods. As an example, data associated with hydraulic fracturing events may be acquired via various sensors. As an example, P-wave data (compressional wave data) can be utilized to assess such events (e.g., microseismic events). Such information may allow for adjusting one or more field operations. As an example, data acquired via the fiber cable sensor 324 can be utilized to generate information germane to a fluid flow-based treatment process (e.g., to determine where fluid pumped into a well may be flowing, etc.).

FIG. 3 shows an example of a table or data structure 308 with some examples of information that may be acquired via the seismic sensor array 305 (e.g., P-wave as “P”, SH-wave as “SH”, SV-wave as “SV”), sensors of the monitoring well 310 (e.g., P, SH, SV) and sensors of the treatment well 320 (e.g., P). In the example of FIG. 3, information may be sensed with respect to position, for example, sensor position, position along a fiber cable sensor, etc. As shown, the fiber cable sensor 324 may sense information at a variety of positions along the fiber cable sensor 324 within the treatment well 320 (see, e.g., F1, F2, F3, F4 to FN).

In the example of FIG. 3, the set of perforations 325-1 are shown as including associated fractures and microseismic events that generate energy that can be sensed by various sensors in the geologic environment 301. Arrows indicate a type of wave that may be sensed by an associate sensor. For example, as mentioned with respect to the table or data structure 308, the seismic sensor array 305 can sense P, SV and SH waves while the fiber cable sensor 324 can sense P waves.

As an example, the equipment 302 can be operatively coupled to various sensors in the monitor well 310 and the treatment well 320. As an example, the equipment 302 may be on-site where wires are coupled from sensors to the equipment 302, which may be vehicle-based equipment (e.g., a data acquisition and/or control truck, etc.). As an example, the equipment 304 may control the pump 303 (e.g., or pumps) that can direct fluid into the treatment well 320. For example, a line is shown as a conduit that is operatively coupled between the pump 303 and the treatment well 320.

As an example, information acquired by the equipment 302 may be utilized to control one or more treatment processes controlled by the equipment 304. For example, the equipment 302 and the equipment 304 may be in direct and/or indirect communication via one or more communication links (e.g., wire, wireless, local, remote, etc.). In such an example, information acquired during a treatment process can be utilized in real-time (e.g., substantially real-time) to control the treatment process. For example, the equipment 302 can acquire data via sensors in the wells 310 and 320 and output information to the equipment 304 for purposes of controlling an on-going treatment process. As an example, such information may be utilized to control and/or to plan a subsequent treatment process, for example, additionally or alternatively to controlling an on-going treatment process.

As an example, a treatment process can include hydraulic fracturing. As an example, acquired data can include microseismic event data. As an example, a method can include determining the extent of rock fracturing induced by a treatment process, which may aim to stimulate a reservoir.

As an example, a method can include hydraulic fracture monitoring (HFM). As an example, a method can include monitoring one or more types of reservoir stimulation processes where one or more of such processes may be performed in stages. As an example, a stage may be of a duration on the order of hours or longer (e.g., several days). As an example, a method can include determining the presence, extent, and/or associated volume of induced fractures and fracture networks, which may be utilized for calculating an estimated reservoir stimulation volume (e.g., ESV) that may assist, for example, in economic evaluation of well performance.

As an example, real-time data may be rendered to a display (e.g., as a plot, plots, etc.). As an example, real-time data may be assessed in real-time (e.g., near real-time that includes computation and transmission times) during perforation flow for one or more sets of perforations. In such an example, such assessments may allow a treatment process to be optimized during the treatment process in real-time (e.g., near real-time). Such assessments may be utilized for one or more post treatment analyses, for example, to plan, perform, control, etc. one or more future treatments (e.g., in a same well, a different well, etc.).

As an example, a method can include acquiring data germane to flow in one or more wells and/or via perforations in one or more wells. As an example, a method can include acquiring data germane to locating one or more fractures. As an example, a method can include a real-time portion and a post-process portion.

As an example, a data acquisition technique may be implemented to help understand a formation, a reservoir, a bore, a bore wall, a fracture, fractures, a fracture network, etc. As an example, a hydraulically induced fracture or fractures may be monitored using one or more borehole seismic methods. For example, while a fracture is being created in a treatment well, a multicomponent receiver array in a monitor well may be used to record microseismic activity generated by a fracturing process.

As mentioned, equipment may include fracturing equipment where such equipment may be employed to generate one or more fractures in a geologic environment. As an example, a method to generate fractures can include a delivery block for delivering fluid to a subterranean environment, a monitor block for monitoring fluid pressure and a generation block for generating fractures via fluid pressure. As an example, the generation block may include activating one or more fractures. As an example, the generation block may include generating and activating fractures.

As an example, a method may be referred to as a treatment method or a “treatment”. Such a method may include pumping an engineered fluid (e.g., a treatment fluid) at high pressure and rate into a reservoir via one or more bores, for example, to one or more intervals to be treated, which may cause a fracture or fractures to open (e.g., new, pre-existing, etc.).

As an example, a fracture may be defined as including “wings” that extend outwardly from a bore. Such wings may extend away from a bore in opposing directions, for example, according in part to natural stresses within a formation. As an example, proppant may be mixed with a treatment fluid to keep a fracture (or fractures) open when a treatment is complete. Hydraulic fracturing may create high-conductivity communication with an area of a formation and, for example, may bypass damage that may exist in a near-wellbore area. As an example, stimulation treatment may occur in stages. For example, after completing a first stage, data may be acquired and analyzed for planning and/or performance of a subsequent stage.

Size and orientation of a fracture, and the magnitude of the pressure to create it, may be dictated at least in part by a formation's in situ stress field. As an example, a stress field may be defined by three principal compressive stresses, which are oriented perpendicular to each other. The magnitudes and orientations of these three principal stresses may be determined by the tectonic regime in the region and by depth, pore pressure and rock properties, which determine how stress is transmitted and distributed among formations.

Where fluid pressure is monitored, a sudden drop in pressure can indicate fracture initiation of a stimulation treatment, as fluid flows into the fractured formation. As an example, to break rock in a target interval, fracture initiation pressure exceeds a sum of the minimum principal stress plus the tensile strength of the rock. To determine fracture closure pressure, a process may allow pressure to subside until it indicates that a fracture has closed. A fracture reopening pressure may be determined by pressurizing a zone until a leveling of pressure indicates the fracture has reopened. The closure and reopening pressures tend to be controlled by the minimum principal compressive stress (e.g., where induced downhole pressures exceed minimum principal stress to extend fracture length).

After performing fracture initiation, a zone may be pressurized for furthering stimulation treatment. As an example, a zone may be pressurized to a fracture propagation pressure, which is greater than a fracture closure pressure. The difference may be referred to as the net pressure, which represents a sum of frictional pressure drop and fracture-tip resistance to propagation (e.g., further propagation).

As an example, a method may include seismic monitoring during a treatment operation (e.g., to monitor fracture initiation, growth, etc.). For example, as fracturing fluid forces rock to crack and fractures to grow, small fragments of rock break, causing tiny seismic emissions, called microseisms. Equipment may be positioned in a field, in a bore, etc. to sense such emissions and to process acquired data, for example, to locate microseisms in the subsurface (e.g., to locate hypocenters). Information as to direction of fracture growth may allow for actions that can “steer” a fracture into a desired zone(s) or, for example, to halt a treatment before a fracture grows out of an intended zone. Seismic information (e.g., information associated with microseisms) may be used to plan one or more stages of fracturing operations (e.g., location, pressure, etc.).

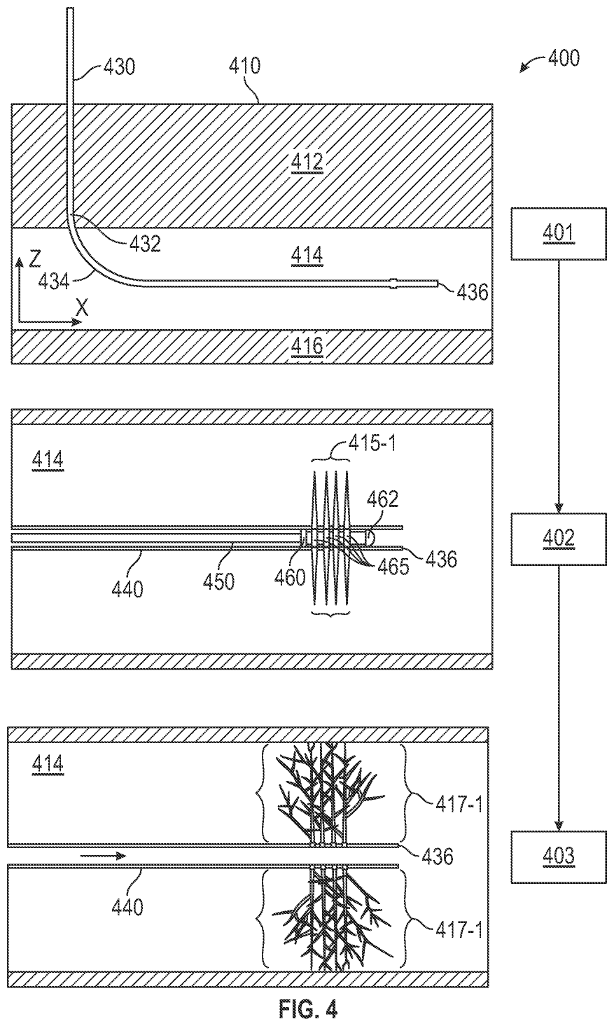

FIGS. 4 and 5 illustrate an example of a method 400 that includes generating fractures. As shown, the method 400 can include various operational blocks such as one or more of the blocks 401, 402, 403, 404, 405 and 406. The block 401 may be a drilling block that includes drilling into a formation 410 that includes layers 412, 414 and 416 to form a bore 430 with a kickoff 432 to a portion defined by a heel 434 and a toe 436, for example, within the layer 414.

As illustrated with respect to the block 402, the bore 430 may be at least partially cased with casing 440 into which a string or line 450 may be introduced that carries a perforator 460. As shown, the perforator 460 can include a distal end 462 and charge positions 465 associated with activatable charges that can perforate the casing 440 and form channels 415-1 in the layer 414. Next, per the block 403, fluid may be introduced into the bore 430 between the heel 434 and the toe 436 where the fluid passes through the perforations in the casing 440 and into the channels 415-1. Where such fluid is under pressure, the pressure may be sufficient to fracture the layer 414, for example, to form fractures 417-1. In the block 403, the fractures 417-1 may be first stage fractures, for example, of a multistage fracturing operation.

Per the block 404, additional operations are performed for further fracturing of the layer 414. For example, a plug 470 may be introduced into the bore 430 between the heel 434 and the toe 436 and positioned, for example, in a region between first stage perforations of the casing 440 and the heel 434. Per the block 405, the perforator 460 may be activated to form additional perforations in the casing 440 (e.g., second stage perforations) as well as channels 415-2 in the layer 414 (e.g., second stage channels). Per the block 406, fluid may be introduced while the plug 470 is disposed in the bore 430, for example, to isolate a portion of the bore 430 such that fluid pressure may build to a level sufficient to form fractures 417-2 in the layer 414 (e.g., second stage fractures).

In a method such as the method 400 of FIGS. 4 and 5, it may be desirable that a plug (e.g., the plug 470) includes properties suited to one or more operations. Properties of a plug may include mechanical properties (e.g., sufficient strength to withstand pressure associated with fracture generation, etc.) and may include one or more other types of properties (e.g., chemical, electrical, etc.). As an example, it may be desirable that a plug degrades, that a plug seat degrades, that at least a portion of a borehole tool degrades, etc. For example, a plug may be manufactured with properties such that the plug withstands, for a period of time, conditions associated with an operation and then degrades (e.g., when exposed to one or more conditions). In such an example, where the plug acts to block a passage for an operation, upon degradation, the passage may become unblocked, which may allow for one or more subsequent operations.

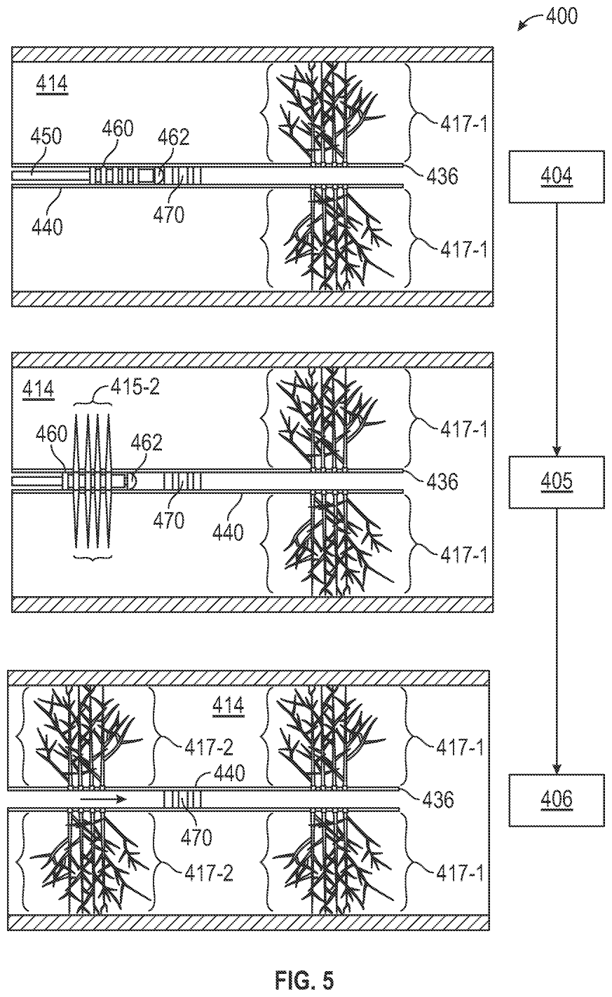

FIG. 6 illustrates an example of a microseismic survey 610, which may be considered to be a method that utilizes equipment for sensing elastic wave emissions of microseismic events (e.g., elastic wave energy emissions caused directly or indirectly by a treatment). As shown, the survey 610 is performed with respect to a geologic environment 611 that may include a reflector 613. The survey 610 includes an injection bore 620 and a monitoring bore 630. Fluid injected via the injection bore 620 generates a fracture 622 that is associated with microseismic events such as the event 624. As shown in the example of FIG. 6, energy 625 of a microseismic event 624 may travel through a portion of the geologic environment 611, optionally interacting with one or more reflectors 613, and pass to the monitoring bore 630 where at least a portion of the energy 625 may be sensed via a sensing unit 634, which may include a shaker, three-component geophone accelerometers isolated from a sensing unit body (e.g., via springs, etc.), coupling contacts, etc. In the example of FIG. 6, the sensed energy includes compressional wave energy (P-wave) and shear wave energy (S-wave).

As shown in the example of FIG. 6, one or more sensors of the sensing unit 634 can be oriented in the monitoring bore 630 with respect to the position of the microseismic event 624 and/or the energy 625 as received by at least one of the one or more sensors of the sensing unit 634. As an example, the orientation of a sensor may be defined in a coordinate system or coordinate systems such that orientation information may be defined as to one or more microseismic events and/or energy received as associated with one or more microseismic events. FIG. 6 shows an approximate diagram of a cross-sectional view of the sensing unit 634 in the monitoring bore 630 of the geologic environment 611 where energy 625 is arriving at the sensing unit 634 at an angle Θ, which may be defined in a range of angles from approximately 0 degrees to approximately 360 degrees (e.g., where 0 and 360).

In FIGS. 1 and 3, various examples of machines can include one or more processors, memory, interfaces, etc. For example, the monitoring equipment 302 (e.g., a truck, etc.), the equipment 304 (e.g., a truck, etc.) and the remote facility 306 can include one or more processors, memory, interfaces, etc. As an example, a vehicle and/or a trailer may include wheels and an engine and/or a motor and one or more processors, memory, interfaces, etc.

As mentioned, a field operation can include using one or more pump systems. As an example, a pump system can include an internal combustion engine that is operatively coupled to a transmission that is operatively coupled to a pump that can pump fluid. As an example, such a pump system may be carried by a vehicle or a trailer.

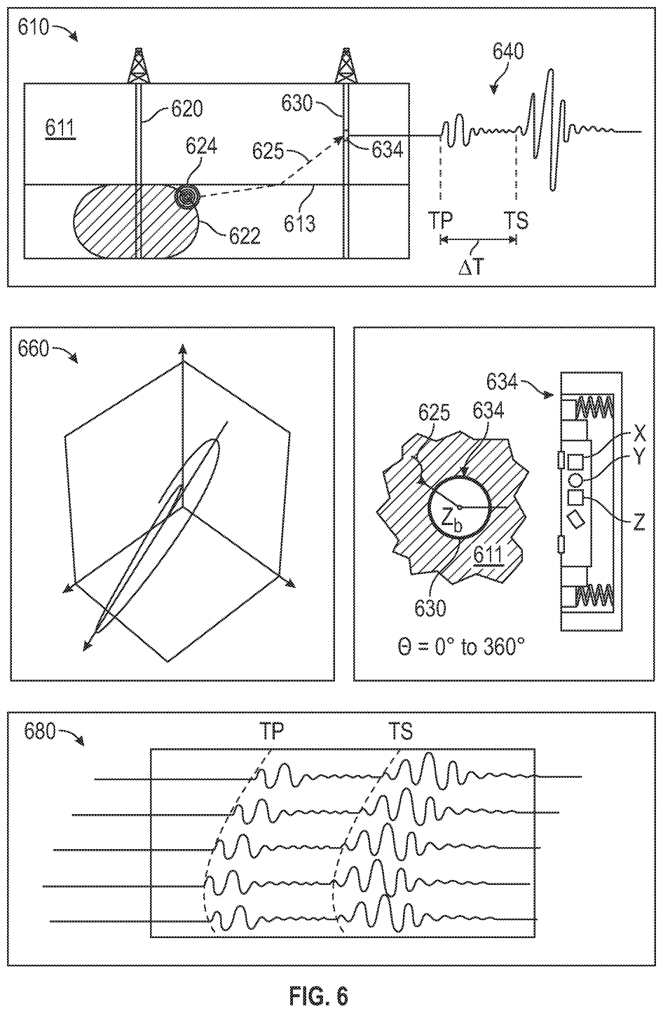

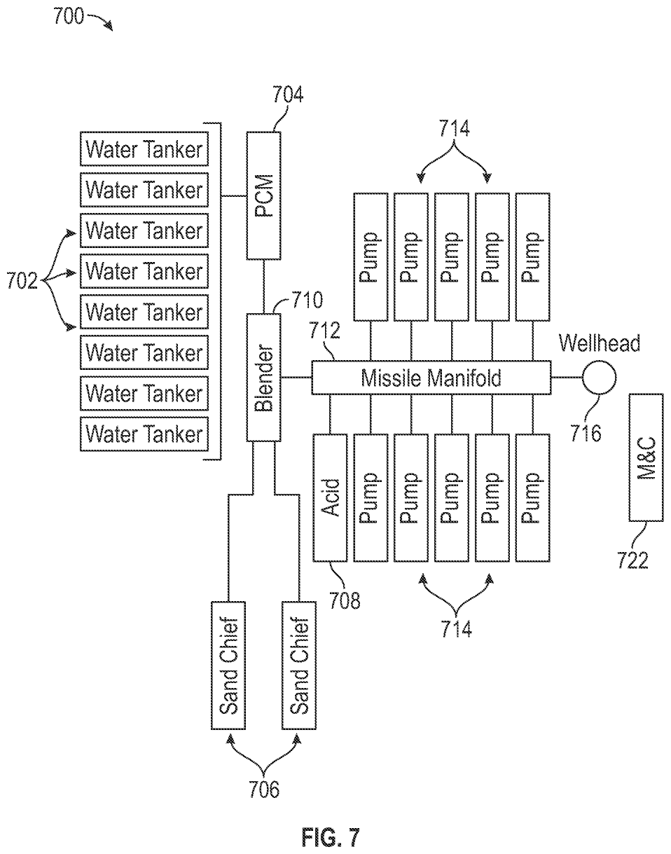

FIG. 7 illustrates an example of a system 700 that includes water tankers 702, a precision continuous mixer (PCM) 704, one or more sand chiefs 706, an optional acid and/or other chemical supply 708, a blender 710, a missile manifold 712, and a fleet of pump systems (see, e.g., blocks labeled “Pump”) 714. The pump systems 714 are operatively coupled to the missile manifold 712, which is supplied with fluid via at least the PCM 704 and the blender 710, which may receive fluid from one or more of the water tankers 702, which can include conduits operatively coupled via a manifold or manifolds. As shown, the system 700 can provide for output of blended fluid, optionally with solids (e.g., sand as proppant, etc.) and optionally with chemicals (e.g., surfactant, acid, etc.), to a wellhead 716, which is a wellhead 716 to at least a partially completed well (e.g., with one or more completion components). As an example, one or more operations may be performed as described with respect to, for example, FIGS. 3, 4, 5 and 6. For example, hydraulic fracturing can be performed using the system 700. FIG. 8 illustrates another example of a system 800 that includes various pumps (e.g., pump systems) 714. As shown, the blender 710 can handle sand (e.g., proppant) 718 and water 720 where pumps 714 can direct a slurry to a wellhead 716.

FIGS. 7 and 8 show monitoring and control equipment (M&C) 722, which may be or include equipment such as the FracCAT equipment (Schlumberger Limited, Houston, Texas). The FracCAT equipment (e.g., a fracturing computer-aided treatment system) includes hardware and software for monitoring, controlling, recording and reporting various types of fracturing treatments. Its real-time displays, plots, surface schematics and wellbore animations present information of a treatment as it occurs, which can provide for decision making using real-time detailed job information from the surface to the perforations. As an example, a framework such as the FracCADE framework (Schlumberger Limited, Houston, Texas) may be utilized, which includes various components for fracture design and evaluation.

During a job, M&C equipment 722 can track job parameters, which may be compared to planned values. M&C equipment 722 can use design specifications to control proppant and additive concentrations in one or more blenders 710. M&C equipment 722 may be operatively coupled to a local area network (LAN) environment, for example, to allow for networking of equipment at a wellsite and provide a connection to the Internet (e.g., through satellite or cellular telephone technology). As an example, Internet connectivity can provide an ability to transmit real-time data from a wellsite to one or more locations (e.g., for real-time analysis, etc.).

As described herein, various types of equipment can perform various types of field operations. As an example, a controller can be operatively coupled to one or more types of equipment. For example, consider automotive equipment, airline equipment, engines, transmissions, mining equipment, material handling equipment, construction equipment, rotating equipment, etc.

As an example, a controller can include or be operatively coupled to a machine learning framework that includes one or more machine learning models. As an example, a multiple linear regression model (MLR model) can be a machine learning predictive model (ML model). As an example, an artificial neural network (ANN) model can be a machine learning predictive model (ML model). As an example, a trained ML model may be implemented for controlling equipment.

As an example, a field operation can include a minifrac operation, which is a relatively small fracturing treatment performed before a main hydraulic fracturing treatment where the minifrac operation aims to acquire job design and execution data and to confirm a predicted response of a treatment interval. The minifrac procedure can provides design data from parameters associated with the injection of fluids and the subsequent pressure decline. A main hydraulic fraction treatment can be tailored (e.g., refined, etc.) according to results of a minifrac treatment. A minifrac operation can be performed as part of a proppant fracturing redesign workflow. For example, such an operation can include performing different pumping tests that yield design parameters for a main treatment. A minifrac operation can be time-consuming and impact operational efficiency. As an example, a method can be utilized to improve operational efficiency, for example, by proceeding without a minifrac procedure to reduce time demands and other operational demands.

As an example, a method can include use of a machine learning (ML) model where machine learning is applied using data (e.g., stored in one or more databases), which can help to streamline calibration treatment, for example, from a multistep to a single-step process for wells.

As an example, a method can include implementing a regression computing framework. For example, a method can include construction of model datasets based on well locations and reservoirs in a manner that aims to reduce inherent error. As an example, a machine learning predictive model can utilize multiple linear regression (MLR).

As an example, a method can utilize model inputs that include parameters analyzed from an injection test with water, where the inputs can include closure pressure, transmissibility, reservoir pressure, and fluid efficiency. As an example, outputs can include design parameters such as one or more of those that may be evaluated from a calibration injection (e.g., consider fluid efficiency with a crosslinked gel).

As an example, a multiple linear regression model can be assessed using an F-test. An F-test is a statistical test in which the test statistic has an F-distribution under the null hypothesis. As an example, an F-test can be used to compare statistical models that have been fitted to a dataset to identify the statistical model that best fits the population from which the data were sampled. In various approaches, statistical models may be fit to data using least squares.

An F-test may be utilized in various regression methods. For example, consider two models, 1 and 2, where model 1 is nested within model 2. Model 1 can be a restricted model and model 2 can be an unrestricted model. For example, model 1 can have p₁ parameters and model 2 can have p₂ parameters, where p₁<p₂, and for a choice of parameters in model 1, the same regression curve can be achieved by some choice of the parameters of model 2. As an example, an F-test may be utilized for deciding whether a model fits the data better than a naive model (e.g., explanatory term being an intercept term where predicted values for the dependent variable are set equal to that variable's sample mean). As an example, an F-test may be utilized in deciding whether there is a structural break in data. For example, a restricted model can use data in one regression while an unrestricted model can use separate regressions, for example, for two different subsets of data. This use of the F-test may be referred to as the Chow test.

As an example, a model with more parameters will tend to be able to fit data at least as good as a model with fewer parameters. Thus, model 2 can give a better (e.g., lower error) fit to data than model 1. Where it is desirable to determine whether model 2 gives a statistically significantly better fit to the data, an F-test may be utilized. As an example, an F-test can provide an F-statistic.

Multiple linear regression can be utilized to predict an outcome variable (y) on the basis of multiple distinct predictor variables (x). For example, with three predictor variables (x), the prediction of y can be expressed by the following equation: y=b₀+b₁*x₁+b₂*x₂+b₃*x₃, where the “b” values can be referred to as regression weights (or beta coefficients). These coefficients measure the association between the predictor variable and the outcome. As an example, “b_j” can be interpreted as the average effect on y of a one unit increase in “x_j”, holding other predictors fixed. In the R-package, a method can include utilizing a library “tidyverse” (see, e.g., https://www.tidyverse.org/; library (tidyverse), install.packages (“tidyverse”), etc.).

For a multiple regression model with intercept, a method can include testing a null hypothesis H₀ and an alternative hypothesis H₁:

$${H}_{0} : {β}_{1} = {β}_{2} = … = {β}_{p - 1} = 0$$

$${H}_{1} : {β}_{j} \neq 0 , for at least one value of j$$

Such testing can be an overall F-test for regression, which can, for example, include the following: (i) state the null and alternative hypotheses; (ii) compute the test statistic assuming that the null hypothesis is true (e.g., F=MSM/MSE=(explained variance)/(unexplained variance)); (iii) find a (1−α)100 percent confidence interval I for (DFM, DFE) degrees of freedom using an F-table or a statistical package; (iv) accept the null hypothesis if F∈I; reject it if F∉I; and (v) use a statistical package to determine the p-value. As an example, an approximation to a p-value may be made based on other entries in an F-table for an appropriate number(s) of degrees of freedom.

In various example trials, F-tests demonstrated that various models were statistically significant and that standard error of each of various models was insignificant. Such analyses demonstrate that a model-based approach can provide for treatment design with acceptable accuracy.

As an example, five candidate wells were chosen for a pilot trial, which allowed for model evaluation as to performance of field operations. The wells were geographically located where data from a relatively high number of offset wells were used to build the model. A method included an injection test with water being pumped and with a proppant fracturing treatment being redesigned based on a prediction of the model using injection test inputs. The method provided for successful placement and evaluation of bottomhole pressure behavior during the treatment to validate prediction of design parameters by the statistical model (e.g., to an acceptable level of accuracy).

The aforementioned approach, which utilized an injection test without minifrac, enhanced operational efficiency by approximately 35 percent to approximately 50 percent, which, in terms of time, can save up to three days per stage of a multi-stage fracturing job. Stimulation operations in 12 vertical and 11 horizontal multistage wells were designed using such an approach, which enhanced operational efficiency by alleviating demand for calibration injection for 52 stages.

Results of various example trials demonstrated a strong correlation between injection test results and design parameters of a proppant fracturing treatment, which enabled skipping steps (e.g., alleviating demand for minifrac). Implementation of the statistical model-based approach reduced complexity of proppant fracturing treatment redesign processes, which enhanced efficiency. Further, given various procedures involved in minifrac, alleviation of such procedures also reduced fracture damage (e.g., formation damage). For example, by not having to perform minifrac steps with crosslinked gel, formation damage can be reduced, which can benefit production.

As an example, a hydraulic proppant fracturing job may include a pad stage followed by slurry stages. In the pad stage, fracturing fluid can be injected into the well to break down the formation and to create a fracture. The pad volume design can be imperative because the volume of fracture created tends to be a fraction of the total pad volume due to fluid leaking off into the formation depending on various parameters including, for example, pumping rate, formation permeability, reservoir pressure. After the design pad volume is pumped, the fracture is expected to grow at a desirable size and the slurry stage can be started. During the slurry stage, the fracturing fluid is mixed with sand/proppant in a blender and the mixture is injected into the fracture volume that was created by the pad stage. After filling the fracture with sand/proppant, the fracturing job is over and the pump can be shut down. As an example, to reduce the injection rate demand, a low leak-off fracturing fluid can be utilized. Proppants tend to be used to keep the fractures propped open and can have a compressive strength that is high enough to bear stresses from the formation acting on the proppant. As an example, a percent pad can be determined with knowledge of a fluid efficiency of a slurry stage fluid, which can be, for example, a fluid that includes a polymeric additive (e.g., to support proppant flow, etc.).

As to a calibration injection (e.g., minifrac), it does include a polymeric additive. As to an injection test, it can be performed without a polymeric additive and, for example, reduce the amount of polymeric additive exposure to a formation. As an example, an injection test approach that is without use of a calibration injection can reduce exposure prior to a main fracturing job. As an example, a main fracturing job may be performed without prior exposure to polymeric additives where an injection test is performed without performing a calibration test.

As an example, fracturing fluid can include one or more of water frac or slick water, linear gel, and crosslinked gel. For example, water frac is water containing a friction reducer and optionally a biocide, surfactant, breaker or clay control additive. Such fluid may have a relatively low viscosity of 2-3 centipoise (cP), which can demand a relatively high pump rate to transport proppant. Relatively small proppant size, like 40/70, may be utilized with such fluid due to its low viscosity and light weight proppant may be utilized due to its low proppant transport capability. Water frac tends to be the least damaging to a proppant pack and finds particular use in high efficiency tight gas wells.

Linear gel can be water containing a gelling agent like guar, hydroxyl propyl guar (HPG), carboxymethyl hydroxypropyl guar (CMHPG), or xanthan, among others. Other optional additives can include buffers, biocide, surfactant, breaker, and clay control. Such a fluid can have a medium viscosity of 10-30 cP, which can result in improved proppant transport and, for example, wider frac compared to water frac fluid. Medium proppant size, like 30/50, may be utilized with such a fluid. Linear gel tends to be more damaging to a proppant pack than water frac; linear gel finds use in both gas and oil wells.

Crosslinked gel is water containing one or more gelling agents as may be used, for example, in linear gel and a crosslinker such as, for example, boron (B), zirconium (Zr), titanium (Ti) or aluminum (Al), among others. Other optional additives can include buffers, biocide, surfactant, breaker, and clay control. A crosslinked gel fluid tends to have a relatively high viscosity of 100-1000 cP, which can result in better proppant transport and, for example, wider fracs compared to linear gel frac fluid. Large proppant sizes, like 20/40 and 16/30, may be utilized with such fluid. Crosslinked gel tends to be more damaging to a proppant pack than linear gel. Crosslinked gel can find use in oil and high liquid wells.

As gas demand continues to increase, so does the demand for better definitions of fracture geometry created by a treatment. A better understanding of the mechanical properties governing a fracturing process can allow for better optimization of a treatment. One or more of various techniques may be used in an effort to optimize a proppant fracturing treatment. Such techniques can include an injection test, a diagnostic fracture injection test (DFIT), a step rate/step down test, and minifrac (e.g., minifrac test).

As described herein, minifrac tests tend to be effective for optimizing a proppant treatment by calibrating a reservoir mechanical model (e.g., a mechanical earth model (MEM)), which is built during a design phase. The minifrac operation is part of the hydraulic fracturing process that includes creating and propagating a small fracture using the same fluid that would be used in the main fracturing treatment. Minifrac intends to create a geometry as similar as possible to that of a designed treatment during an injection period, for example, to observe and measure pressure behavior and calculate hydraulic fracture parameters such as: the instantaneous shut-in pressure (ISIP), fracture closure pressure, fracture gradient, fluid leakoff coefficient, and fluid efficiency, among others.

The minifrac test tends to be associated with other tests such as, for example, the injection test and step rate/step down test. The latter tests are utilized additionally to determine other parameters such as: rate and pressure to extend and propagate an induced fracture, reservoir permeability and leakoff characteristics, among others. These properties are utilized for characterizing the reservoir, conducting approximate assessments to evaluate well potential, and optimizing the main fracture treatment design. However, as described herein, the execution of these various, different procedures (e.g., tests) for calibration introduce complexity and inefficiency in an overall fracturing process.

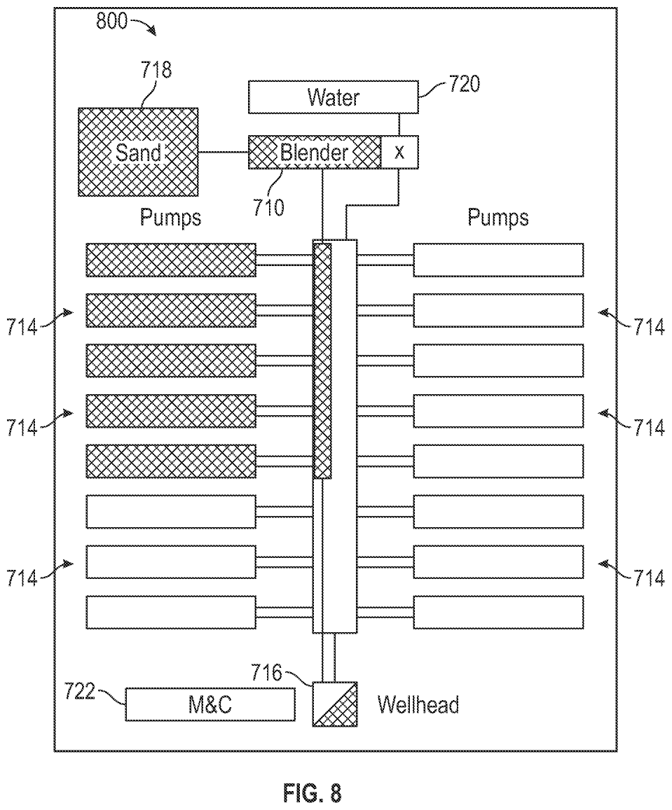

FIG. 9 illustrates an example of a workflow 900 that can be utilized for fracture treatment design (e.g., or redesign). As shown, the workflow 900 includes procedures A, B, C, D and E. Procedure A pertains to acquisition of borehole logs, procedure B pertains to construction of a MEM, procedure C pertains to preliminary design, procedure D pertains to injection and minifrac, and procedure E pertains to MEM calibration. As shown, a preliminary design (C) is “redesigned” using data acquired via at least both injection and minifrac (D) where the data are utilized to calibrate (E) the constructed MEM (B). As such, the calibrated MEM (E) is based at least on acquired logs (A) and at least both injection and minfrac data (D). A calibrated MEM can allow for tailoring treatment parameters for a treatment operation that aims to fracture a formation. Such a calibrated MEM may provide for simulation of fracture generation and, for example, microseismic monitoring (e.g., in combination with acquired microseismic data). It should be appreciated that the procedures of the workflow 900 illustrated in FIG. 9 are merely exemplary, and not intended to be limiting. Indeed, in other embodiments, more or fewer procedures may be used as part of the workflow 900.

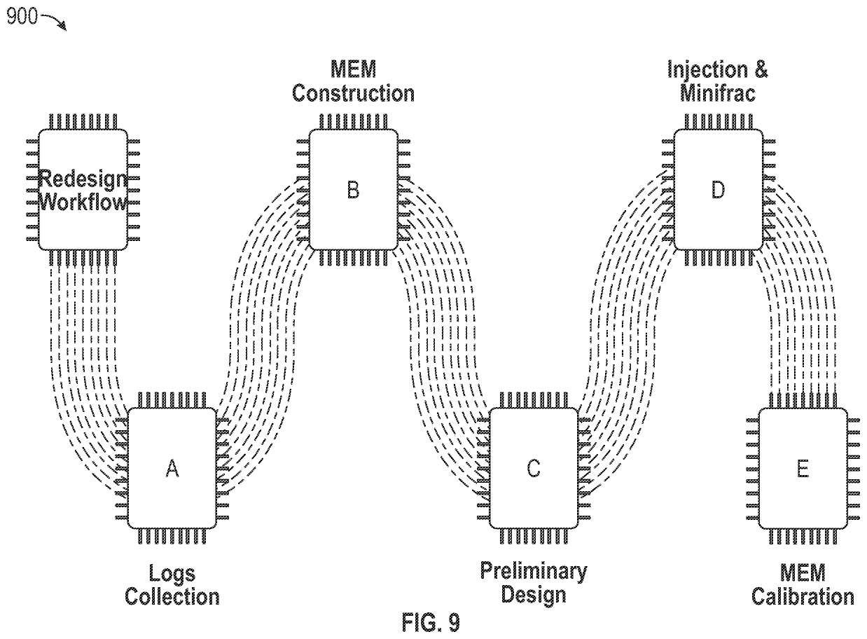

FIG. 10 illustrates an example workflow 1010 for a vertical well or other single stage well and an example workflow 1030 for a horizontal well or other multi-stage well. As shown, the workflow 1010 includes calibration injections: an injection/falloff test (day 2), step rate & step-down test followed by the minifrac (day 3). The workflow 1010 shows the timeline for a single fracturing job from rig up to rig down, which takes approximately 6 days, where the injection/falloff test is at day 2 and the minifrac at day 3, with the main fracture treatment at day 5. As shown, the workflow 1030 includes an injection test for each stage (days 2 and 6) and a minifrac for each stage (days 3 and 7). As an example, consider a reservoir such as the Ghawar reservoir, which can be characterized by its heterogeneity. In horizontal wells with multi-stage proppant fracturing, different reactions might be seen in two consequents stages even if the lateral is landed in the same layer. Such differences can demand pumping the calibration test in each stage, for example, when a different pressure behavior is seen compared to one or more previous stages. It should be appreciated that the stages of the workflows 1010, 1030 illustrated in FIG. 10 are merely exemplary, and not intended to be limiting. Indeed, in other embodiments, more or fewer stages may be used as part of the workflows 1010, 1030.

By analyzing the workflows for proppant treatment, the redesign process (injection, minifrac and preparation) may take considerable time. Improvements can be made in operational efficiency by utilizing a method that can do without minifrac. As an example, to reduce complexity of workflows 1010, 1030 of FIG. 10, and increase overall efficiency, a workflow can perform fracturing model calibration based on the results of an injection test (i.e., without minifrac). In such an example, an opportunity exists to shorten a workflow by one or more days.

As an example, a method can include an approach that uses data from offset wells with successful proppant fracturing conducted. For example, a method can include utilizing injection test results and decline compared with datasets from offset wells to determine which dataset or datasets can be used for reference. Such a method can include performing one or more computational statistical analyses on one or more execution datasets from one or more reference offsets in a manner that aims to further strengthen confidence for redesign.

As an example, a method can include analyzing placement parameters by looking at the different times from the execution data. In such a method, the pad percentage calculated from execution data based on successful placement in close offset wells being treated in the same formation sublayer was used as a reference. Below is a description of an example analysis:
t_{pad}: time at which pad fluid reached perfs;
tₚᵣₒₚ: time at which first prop step reached perfs;
tₜₛₒ: time at which tip screen-out was achieved based on the BH Pressure trend.

$$Fracture Efficiency during MainFRAC ( {η}_{m f} ) = \frac{{t}_{p r o p} - {t}_{p a d}}{{t}_{t s o} - {t}_{p a d}}$$

$$Pad Ratio for MainFRAC Execution = \frac{1 - {η}_{m f}}{1 + {η}_{m f}}$$

The foregoing approach tends to be robust, though can introduce some time demands to process in a preparation phase for each well. Such an approach can demand collection of offset well data as a first step, followed by an in-depth analysis of the main treatment execution data for each stage. As described below, a method can, for example, utilize a machine learning approach that can reduce this redundancy for each well.

As an example, pad percentage (e.g., or pad ratio) can be determined based on an estimated efficiency, for example, consider a machine learning approach that can utilize injection test data as input and that can output an estimated efficiency. An example equation can be: Pad Percentage=((1−effiency)/(1+efficiency))*100. In such an example, for an efficiency of 50 percent (e.g., 0.5), the pad percentage can be 33 percent. The result can be the same as the equation above (see, e.g., mf). As an example, pad percentage or pad fraction can be defined using a ratio of (pad volume)/(pad+slurry stages).

As described herein, a method can utilize a computational framework that can include one or more libraries such as one or more R package libraries. As mentioned, a method can utilize multiple linear regression (MLR) analysis, for example, to predict values of a dependent variable, yᵢ, given a set of p explanatory variables (xᵢ,1, . . . , xᵢ,p)

$${y}_{i} = {β}_{0} + {β}_{1} {x}_{i , 1} + {β}_{2} {x}_{i , 2} + … + {β}_{p - 1} {x}_{i , p - 1} + {∈}_{i}$$

where β₀ is a constant term and β₁ to βₚ₋₁ are the coefficients relating the p explanatory variables to the variable of interest and ∈i is the error term which may be assumed to have a mean of zero and be normally distributed.

As an example, the predicted value y can be fluid efficiency of the main job fluid and, for example, explanatory variables x_{i,1} . . . x_{i,p} can be injection test parameters. As mentioned, a method can include estimating efficiency and using an estimated efficiency to determine a pad percentage (e.g., or pad ratio).

As an example, model datasets for a machine learning predictive model can be constructed based on well locations and reservoirs to reduce inherent error. In such an example, each dataset may include approximately 50 wells. A database can be, for purposes of machine learning and generating a trained machine learning model, divided into a training dataset (e.g., to build the model) and a test dataset to evaluate it. For example, consider a ratio of training to testing data of 80:20.

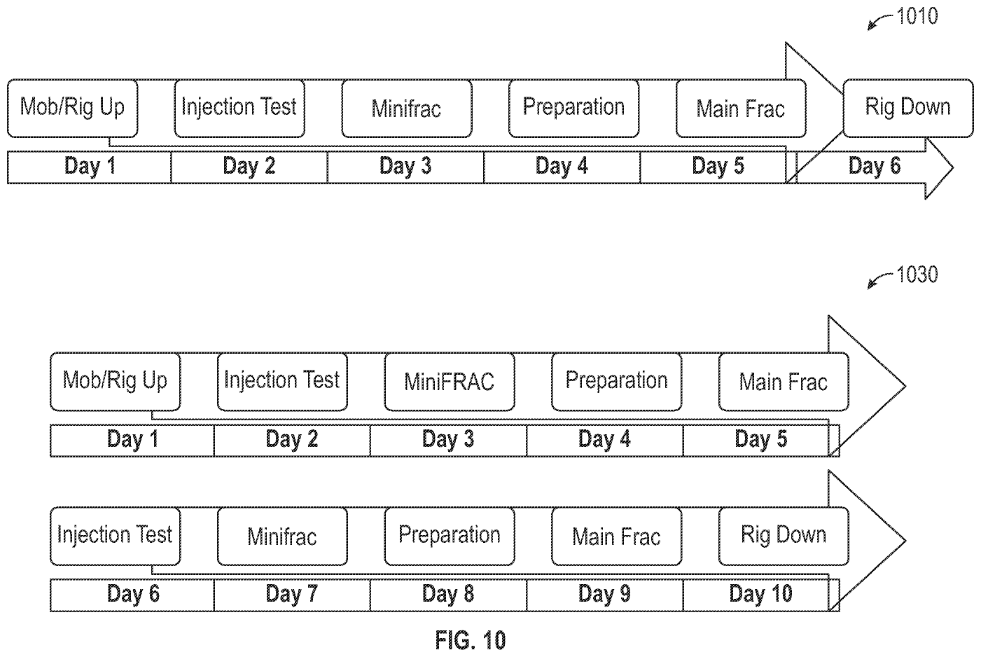

FIG. 11 illustrates an example of a workflow 1100 where a redesign process includes reservoir parameter determinations using an injection test, a data fracturing analysis process, and a redesign meeting prior to a main treatment (main fracturing job). As shown, injection test data can be analyzed using a DataFRAC framework to output reservoir parameters that can be utilized to calibrate a MEM where a calibrated MEM can be utilized for fracture simulation to generate results for an optimal redesign. As shown, the MEM can be a finite element (FE) model that can depend one various parameters such as closure pressure, extension pressure, Young's modulus, Ct, and fracture height. It should be appreciated that the stages of the workflow 1100 illustrated in FIG. 11 are merely exemplary, and not intended to be limiting. Indeed, in other embodiments, more or fewer stages may be used as part of the workflow 1100.

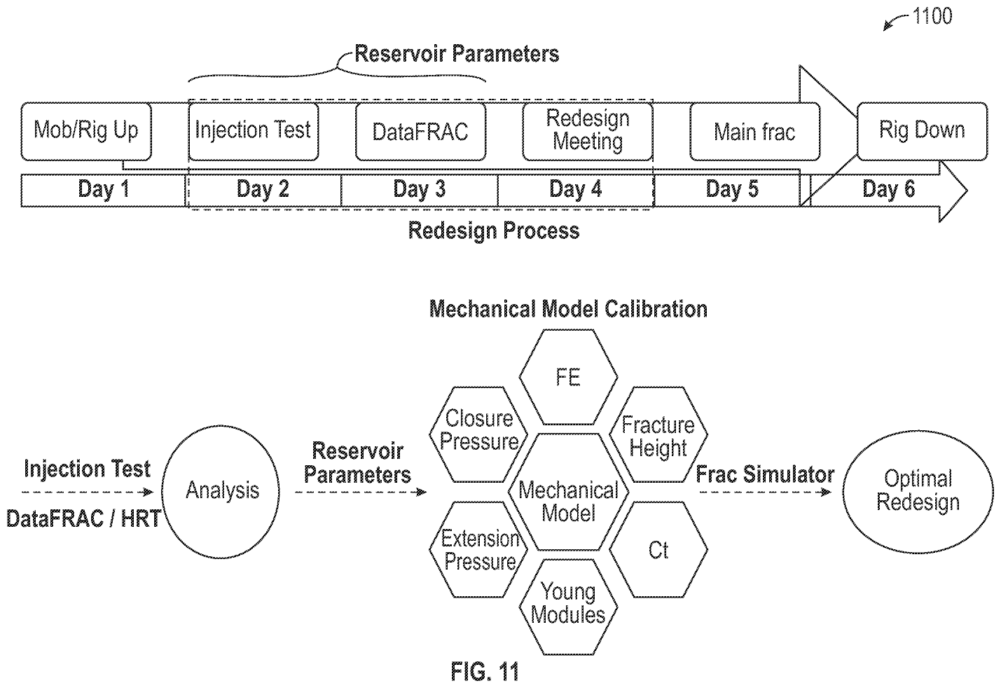

FIG. 12 illustrates an example of a workflow 1200 where injection test parameters are input to a machine learning predictive model that can output fluid efficiency data (e.g., percentage) that can be utilized to determine pad data (e.g., percentage). As shown, offset wells data can be utilized along with information as to treatment size and maximum proppant concentration to arrive at an optimal redesign. The workflow 1200 includes an injection test parameters reception block 1210, a machine learning predictive model block 1212, a fluid efficiency block 1214, a pad block 1216, an offset wells data reception block 1220, a maximum proppant concentration block 1222, and a treatment size block 1240. As shown, the various blocks can be utilized, for example, as part of a computational framework, for outputting an optimized design, as indicated by an output block 1260.

As mentioned, a percent pad can be determined with knowledge of a fluid efficiency of a fracturing fluid, which can be, for example, a fluid that includes a polymeric additive (e.g., to support proppant flow, etc.). As described herein, various operational techniques can be utilized to determine fluid efficiency such as minifrac, which involves utilization of water with polymeric materials, which can result in formation damage. As described herein, another approach can utilize an injection test without minifrac where injection test data can be input to a machine learning predictive model such as the multiple linear regression (MLR) model of the machine learning predictive model block 1212 to output fluid efficiency (e.g., to determine an estimated fluid efficiency). In the workflow 1200, the block 1214 can provide a slurry stage fluid efficiency from which a pad percentage can be determined per block 1216. As mentioned, a model-based approach can reduce, for example, one or more of time, water utilization, chemical utilization, and formation damage. As an example, a reduction in formation damage may enhance ultimate recovery.

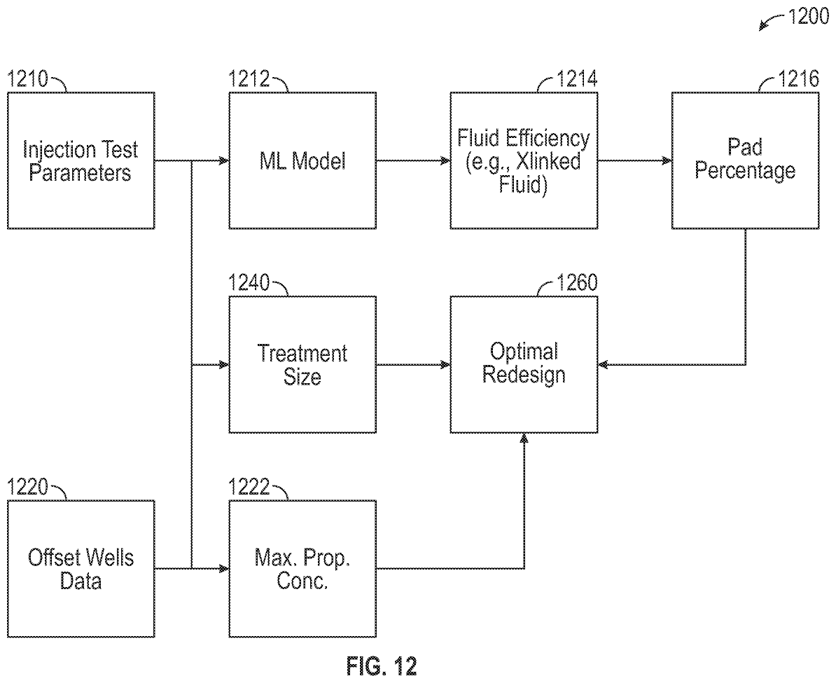

FIG. 13 illustrates an example of a workflow 1300 where a main fracture treatment can be performed within a 24-hour period along with an injection test where, for a single fracture treatment, from a rig up to rig down process, the overall workflow 1300 may be on the order of several days (e.g., three days). As an example, a method can include preprocessing where multiple linear regression (MLR) may be utilized, which can include various assumptions. For example, multiple linear regression can be performed on a basis that a relationship between independent and dependent variables is to be linear. Further, for example, a method can include checking for outliers, as multiple linear regression can be sensitive to outlier effects. As to a linearity assumption, it may be tested, for example, via a scatter plot approach and/or one or more other suitable approaches. It should be appreciated that the stages of the workflow 1300 illustrated in FIG. 13 are merely exemplary, and not intended to be limiting. Indeed, in other embodiments, more or fewer stages may be used as part of the workflow 1300.

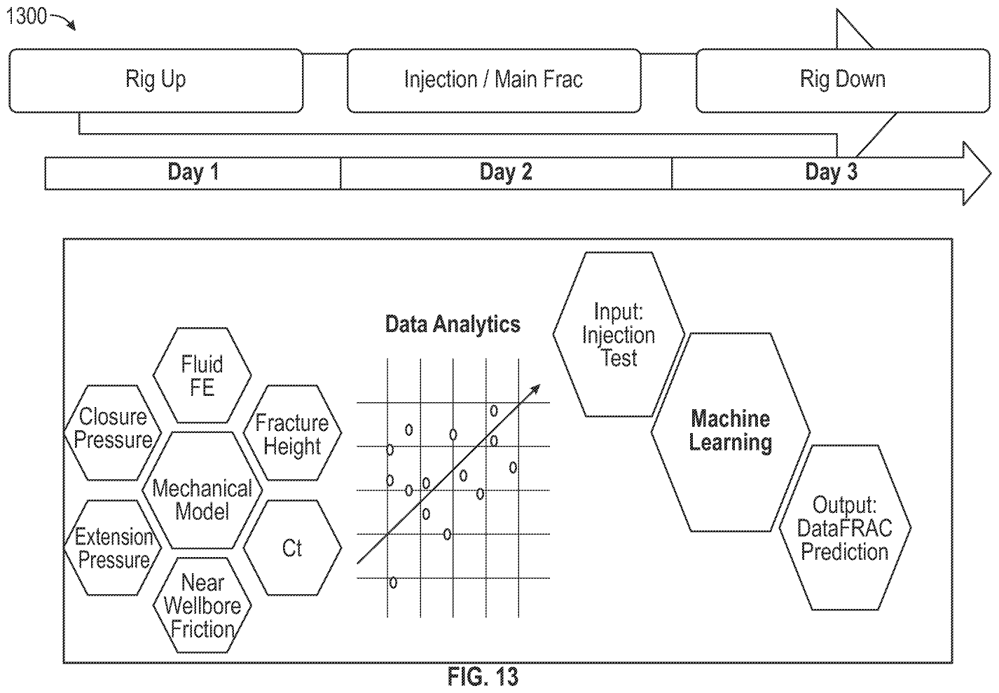

FIG. 14 illustrates an example table 1400 that includes regression, residual and total data, where F-statistics (e.g., F values) are indicated, along with an “F critical” value. The data in the table 1400 provides for statistical validation of the model using the F-test. Specifically, the table 1400 shows a summary of results as an analysis of variance (ANOVA) table.

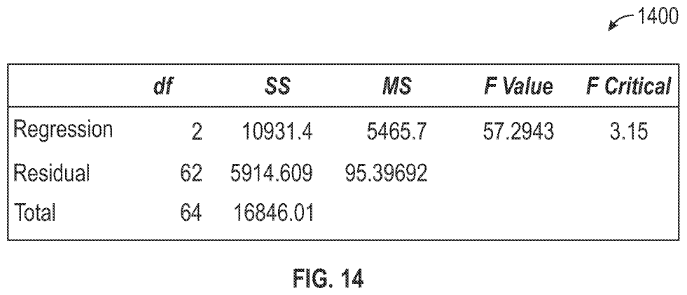

With the foregoing in mind, FIG. 15 illustrates an example of a method 1500 that can be utilized for assessing various model inputs 1502, labeled as Model Input 1 (e.g., 1502-1) through Model Input n (e.g., 1502-n). The method 1500 includes various decision blocks such as decision blocks for linearity 1504, error independence 1506, normality of error 1508, equal variances 1510, increasing R-Square 1512, R-Square comparison to a threshold value 1514, and F-testing 1516. As indicated, depending on F-test results, a model can be evaluated on test data (block 1518) and, for example, utilized in one or more workflows, which may be for one or more hydraulic fracturing operations that may be performed, for example, without performing minifrac. As shown, the method 1500 can include a loop where inputs can be introduced iteratively (e.g., one by one, as per block 1520) for purposes of model fitting, etc. (e.g., block 1522). As shown, where an R-Square is not increasing, an input may be disregarded (e.g., filtered out, as per block 1524); whereas, one or more others can be retained and, for example, compared to an R-Square threshold (e.g., R-Square greater than 0.7, in the illustrated embodiment, as per block 1514). The method 1500 may be utilized for multiple linear regression model building (e.g., revision, tuning, etc.), for example, in the context of one or more types of hydraulic fracturing operations.

In certain embodiments, a linear or non-linear model may be used for machine learning. For example, in certain embodiments, a model such as a MLR model can be evaluated. For example, consider use of one or more criteria for model evaluation. In an example trial, four criteria were used for evaluation: (i) successful placement of the job where approach was utilized; (ii) operational efficiency improvement of the fracturing process; (iii) flow back time reduction; and (iv) reduced utilization of fresh water.

After validating the model statistically, as mentioned, in a pilot trial, five candidate wells were selected to evaluate the model in the field. The wells were geographically located where a high number of offset wells were used to build the model. In the pilot trial, an injection test with water was pumped, and the proppant fracturing treatment was redesigned based on the prediction of the model using the injection test inputs (without use of minifrac). The pilot trial utilized the example workflow 1200 of FIG. 12.

The evaluation of the redesign was performed by analyzing the bottomhole pressure behavior during the treatment. A comparison between the redesign simulation and the actual job parameters validated that the design parameter predicted by the statistical model were accurate. The pilot trial demonstrated efficiency enhancement (e.g., frac and flow back) and a reduction in freshwater utilization. In addition, the pilot trial demonstrated a strong correlation between the injection test results and fluid efficiency determined form a minifrac. As an example, a model may be evaluated using data such as, for example, maximum proppant concentration and job size (see, e.g., blocks 1222 and 1240 of the workflow 1200). For example, a correlation analysis may be performed between injection test results and the main job parameters such as maximum proppant concentration and job size achieved.

As an example, one or more machine learning techniques may be utilized with respect to an injection test approach, for example, without minifrac. For example, consider clustering analysis using the K-mean algorithm, which may offer a flexible way to streamline a redesign process. As an example, a recurrent neural network and/or deep neural network may be used as a tool or tools to predict main job parameters, which may include input such as data from one or more open hole logs of a targeted zone, etc. In various examples, however, data can be somewhat limited. For example, some approaches demand a relatively large amount of training data (e.g., a bigger database), which might not be available or possible to create from a single field, particularly depending on development phase, progress, etc., of the field (e.g., how many wells have been drilled, completed, etc.).

As described herein, a correlation between injection test results and main job fluid efficiency is shown and acceptably modeled in a manner that can streamline workflows in the field. In certain embodiments, a MLR approach can be utilized to capture the correlation(s). Results have indicated that the main job fluid efficiency was strongly correlated to the reservoir pressure and treated water fluid efficiency determined from the injection test analysis. The statistical model showed a high correlation factor (e.g., 80 percent) with relatively low standard error, making it a reliable tool to redesign the main job.

The impact of the aforementioned redesign approach on fracture treatment can be beneficial in more than one regard. For example, analyses have demonstrated areas of improvement that include, among other things: (i) reduction of water usage by 30 percent, (ii) enhancement of the operation efficiency by 30 percent; and (iii) reduction of the flow back time by 20 percent.

As an example, a method can include predicting efficiency from crosslinked fluid based on injection test results. As an example, a method can include utilizing multiple input variables from an injection test. As an example, a method can include performing an iterative process of assumption verification for individual input variables to filter for model inputs (e.g., to filter available inputs for suitable model inputs, etc.). As an example, a method can utilize a combination of filtered independent variables that can be optimized independent variables for suitably high R-squared value(s). As an example, a method can include determining a set of input variables such as, for example, treated water fluid efficiency and reservoir pressure. As an example, a method can include assessing model predicted values versus real values (e.g., for multiple data points). As an example, a model may be subjected to an F-test, which may provide for validation.

As an example, a method can provide for reduced water utilization, which may stem at least in part from foregoing minifrac (e.g., using a predictive model instead of minifrac). As an example, a calibration injection can demand a considerable amount of water such as 300 bbl to 500 bbl of fresh water utilization. As an example, a method can proceed without calibration injection where a model is utilized for predicting output from such a calibration injection operation. In such an example, the amount of water utilized can be reduced in a workflow where the reduction occurs prior to a main job.

As described herein, a workflow can utilize a model-based approach to reduce water consumption (e.g., by 30 to 40 percent, etc.); reduce flowback time; reduce polymer utilization (e.g., polymer can damage reservoir) where a reduction may occur as a model-based approach can utilize, for example, 20 percent less polymer; and/or reduce clean-up demands as fracturing fluid is to be cleaned up after the treatment is performed where time demand for a cleanup is proportional to the fluid volume pumped. As an example, a model-based approach can reduce flowback/cleanup time by approximately 15 percent to approximately 20 percent. As to enhancement of operational efficiency, by skipping operational time for minifrac and reducing flowback time, efficiency can gained, which may be, for example, up to approximately 30 percent.

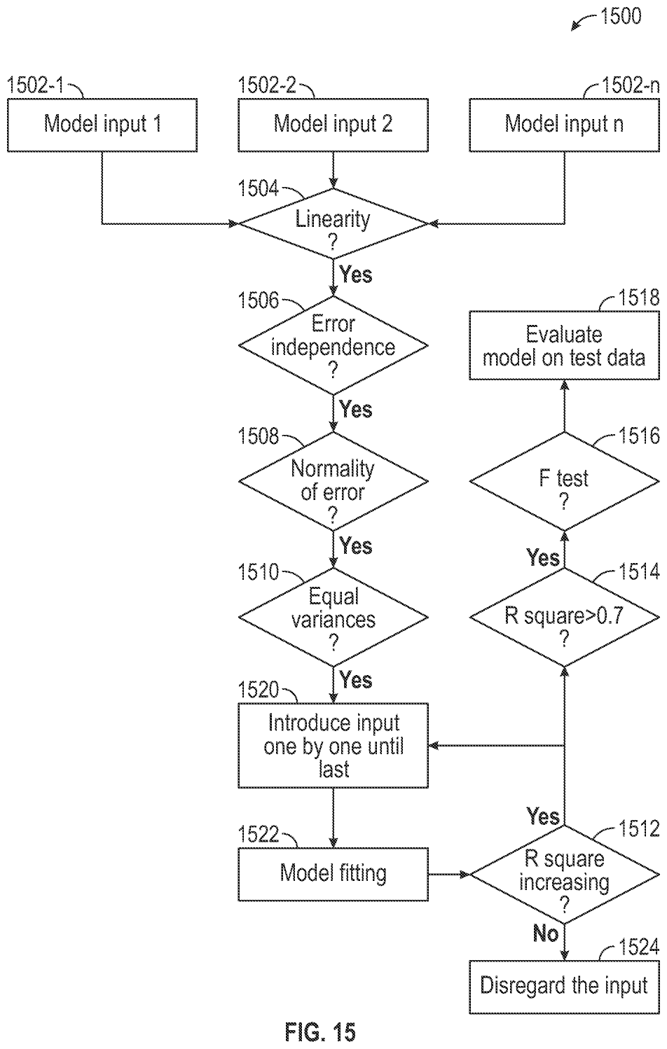

FIG. 16 illustrates an example of a method 1600 that includes a reception block 1610 for receiving data responsive to an injection test performed in a well in fluid communication with a subterranean reservoir; a determination block 1620 for determining operational parameters of a hydraulic fracturing operation using at least a portion of the data and a model; and an issuance block 1630 for issuing one or more control commands to perform the hydraulic fracturing operation on the subterranean reservoir using the operational parameters.

In the example of FIG. 16, a system 1690 includes one or more information storage devices 1691, one or more computers 1692, one or more networks 1695 and instructions 1696. As to the one or more computers 1692, each computer may include one or more processors (e.g., or processing cores) 1693 and memory 1694 for storing the instructions 1696, for example, executable by at least one of the one or more processors. As an example, a computer may include one or more network interfaces (e.g., wired or wireless), one or more graphics cards, a display interface (e.g., wired or wireless), etc.

The method 1600 is shown along with various computer-readable media blocks 1611, 1621, and 1631 (e.g., CRM blocks). Such blocks may be utilized to perform one or more actions of the method 1600. For example, consider the system 1690 of FIG. 16 and the instructions 1696, which may include instructions of one or more of the CRM blocks 1611, 1621 and 1631.

As an example, a method can include receiving data responsive to an injection test performed in a well in fluid communication with a subterranean reservoir; determining operational parameters of a hydraulic fracturing operation using at least a portion of the data and a model; and issuing one or more control commands to perform the hydraulic fracturing operation using the operational parameters. In such an example, the method can include determining fluid efficiency for fluid that comprises a cross-linked gel using treated water fluid efficiency. For example, the method can include determining treated water fluid efficiency using the data, inputting the treated water fluid efficiency to the model, and determining the fluid efficiency for the fluid that comprises the cross-linked gel as an output of the model.

As an example, a model can be a regression model. For example, consider a multiple linear regression (MLR) model. As an example, a method can include building a model. For example, consider utilizing data from one or more hydraulic fracturing operations performed at one or more offset wells for building a model. In such an example, the one or more offset wells can be in fluid communication with a subterranean reservoir and may be more than approximately 5 in number. As an example, a method can include building a model using offset wells data from less than 100 offset wells, which may be in fluid communication with a common reservoir (e.g., a common formation).

As an example, operational parameters can be redesign operational parameters of a base hydraulic fracturing design. For example, redesign operational parameters can correspond to an optimal redesign of the base hydraulic fracturing design. As an example, a base design may be a default design for a well in a particular region.

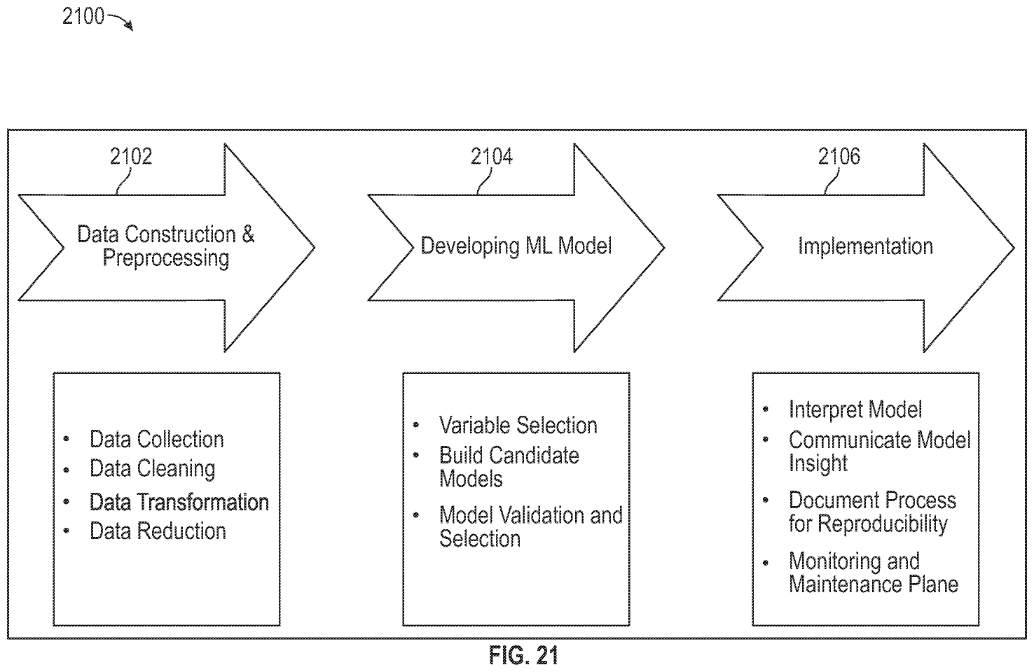

As an example, a method can include building a model in a manner that utilizes an F-test. For example, consider building a MLR model in a manner that utilizes an F-test (see, e.g., FIG. 22, etc.).

As an example, a method can include receiving data where the data can include data associated with one or more of closure pressure, transmissibility, reservoir pressure, and fluid efficiency.

As an example, operational parameters can include at least one operational parameter associated with fluid efficiency, for example, where the fluid efficiency can be a fluid efficiency of a fluid with a crosslinked gel, and, for example, where a hydraulic fracturing operation utilizes the fluid with the crosslinked gel.

As an example, a method can include issuing one or more control commands, which may be issued to a controller that is operatively coupled to one or more pieces of hydraulic fracturing equipment. As an example, a control command can be a signal, an instruction, etc., that causes a piece of equipment or pieces of equipment to perform one or more actions. As an example, a pump may receive a control command as to a pump rate for pumping material; a mixer may receive a control command as to a mixing rate; a valve may receive a control command as to how open or how closed the valve may be; an injector may receive a control command as to how much material to inject (e.g., consider chemical injection into fluid, etc.); a fleet of equipment may receive a control command to cause the fleet to operate in a coordinated manner, which may include some equipment operating differently than other equipment; etc. As an example, a control command can be or depend on a pad percentage (or ratio), a fluid efficiency, a value output by a trained machine model, etc.

As an example, operational parameters can include a fluid efficiency parameter of a hydraulic fracturing fluid for use in performing the hydraulic fracturing operation. As an example, operational parameters can include a pad parameter for a pad stage fluid wherein the pad parameter depends on a fluid efficiency of a slurry stage fluid.

As an example, a system can include a processor; memory accessible to the processor; processor-executable instructions stored in the memory and executable to instruct the system to: receive data responsive to an injection test performed in a well in fluid communication with a subterranean reservoir; determine operational parameters of a hydraulic fracturing operation using at least a portion of the data and a model; and issue one or more control commands to perform the hydraulic fracturing operation on the subterranean reservoir using the operational parameters.

As an example, one or more computer-readable storage media can include computer-executable instructions to instruct a computing system to: receive data responsive to an injection test performed in a well in fluid communication with a subterranean reservoir; determine operational parameters of a hydraulic fracturing operation using at least a portion of the data and a model; and issue one or more control commands to perform the hydraulic fracturing operation on the subterranean reservoir using the operational parameters. As an example, a system may include instructions, which may be provided to analyze data, control a process, perform a task, perform a work step, perform a workflow, etc.

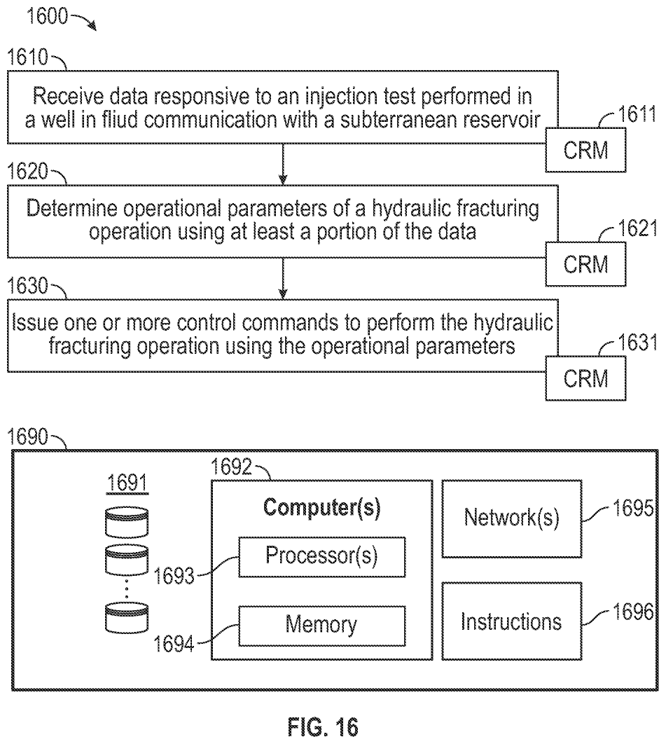

FIG. 17 illustrates components of an example of a computing system 1700 and an example of a networked system 1710. The system 1700 includes one or more processors 1702, memory and/or storage components 1704, one or more input and/or output devices 1706 and a bus 1708. In an example embodiment, instructions may be stored in one or more computer-readable media (e.g., memory/storage components 1704). Such instructions may be read by one or more processors (e.g., the processor(s) 1702) via a communication bus (e.g., the bus 1708), which may be wired or wireless. The one or more processors may execute such instructions to implement (wholly or in part) one or more attributes (e.g., as part of a method). A user may view output from and interact with a process via an I/O device (e.g., the device 1706). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1710. The network system 1710 includes components 1722-1, 1722-2, 1722-3, . . . 1722-N. For example, the components 1722-1 may include the processor(s) 1702 while the component(s) 1722-3 may include memory accessible by the processor(s) 1702. Further, the component(s) 1722-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

As described in greater detail herein, diagnostic pumping techniques are used routinely in proppant fracturing design. The pumping process can be relatively time consuming; however, it yields technical confidence in treatment and productivity optimization. Recent developments in data analytics and machine learning can aid in shortening operational workflows and enhance project economics. Supervised learning was applied in the embodiments described below to develop a digital database to streamline the process and affect the design framework.

Five classification algorithms were utilized as candidates for implementation. The database was constructed through heterogeneous reservoir plays from the injection/falloff outputs. As described in greater detail herein, the algorithms used were support vector machine, decision tree, random forest, multinomial, and XGBoost. The number of classes was sensitized to establish a balance between model accuracy and prediction granularity. Fifteen cases were developed for a comprehensive comparison. A complete machine learning framework was constructed to work through each case set, along with hyperparameter tuning to maximize accuracy. After the model was finalized, an extensive field validation workflow was deployed.

The target outputs selected for the model were crosslinked fluid efficiency, total proppant mass, and maximum proppant concentration. The unsupervised clustering technique with a t-SNE algorithm that was used first lacked accuracy. Supervised classification models showed better predictions. Cross-validation techniques showed an increasing trend of prediction accuracy. Feature selection was done using one-variable-at-a-time (OVAT) and simple feature correlation. Because the number of features and the dataset size were relatively small, no features were eliminated from the final model building. Accuracy and F1 score calculations were used from the confusion matrix for evaluation, and XGBoost showed excellent results with an accuracy of 74-95% for the output parameters. Fluid efficiency was categorized into three classes and yielded an accuracy of 96%. Proppant concentration and proppant mass predictions showed 77%-86% accuracy, respectively, for the six-class case. The combination of high accuracy and fine granularity confirmed the potential application of machine learning models. The ratio of training to testing (e.g., holdout) across all cases ranged from 80:20 to 70:30. Model validations were done through an inverse problem of predicting and matching the fracture geometry and treatment pressures from the machine learning predictive model design and the actual net pressure match. The synthetic data for the simulations was obtained using advanced multiphysics domain knowledge. A few advantages of this innovative design approach showed four areas of improvement, among others: reduction in polymer consumption by 30%, reduction of the flowback time by 25%, reduction of water usage by 30%, and enhanced operational efficiency by 60-65%. The pre-trained model may then be applied on the field data.

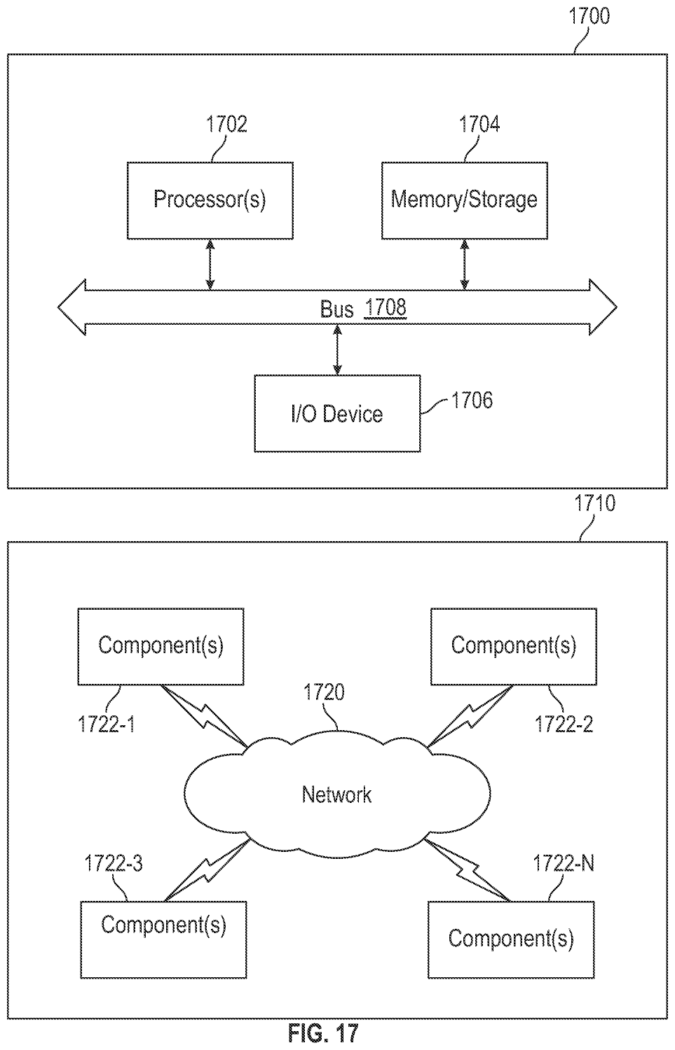

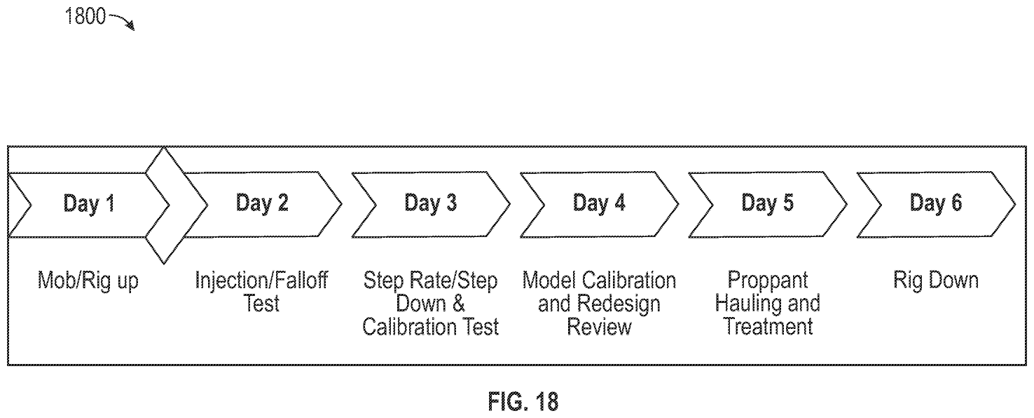

Similar to FIG. 10, FIG. 18 illustrates an example workflow 1800 of proppant fracturing treatment operations. As shown, the workflow 1800 includes mobilization/rig up (day 1), an injection/falloff test (day 2), a step rate & step-down test followed by the minifrac (day 3), model calibration and redesign review (day 4), proppant hauling and treatment (day 5), and rig down (day 6). The embodiments described below employ data mining to enhance traditional workflows in the fracturing world. In particular, the embodiments described below predict the fracturing treatment design parameters, such as maximum proppant concentration, total proppant mass, fracturing fluid efficiency, injection treatment rate, among others. The machine learning workflow utilizes only the parameters analyzed from an injection/falloff test such as shut-in pressure (ISIP), closure pressure, P_star (initial slope of the pressure decline curve), reservoir pressure, treated water fluid efficiency, transmissibility, Gc (G-function time at closure), and ClCr (leakoff ratio of pressure drop in reservoir and total pressure drop, which gives the dominant leakoff mechanism), among others. As illustrated in the machine learning enabled technical and operational workflow 1900 illustrated in FIG. 19, the embodiments described below allow operators to completely skip the datafrac/minifrac diagnostic steps described herein, and can enhance the design process as well as operations efficiency. It should be appreciated that the stages of the workflows 1800, 1900 illustrated in FIGS. 18 and 19 are merely exemplary, and not intended to be limiting. Indeed, in other embodiments, more or fewer stages may be used as part of the workflows 1800, 1900.

In certain embodiments, in addition to direct application, the machine learning predictive model may be further trained on operational data from the field, and fine-tuned to the fields of interest. It may be appreciated by those skilled in the art that the cost function to find the machine learning parameters may be modified to give 100% weight to the new operational data and 0% weight to the synthetic data, 0% weight to the new operational data and 100% weight to the synthetic data, or any fraction in between.

As described in greater detail herein, hydraulic fracturing has evolved as an indispensable technique for gas exploration and development, especially as the development strategy moves towards tighter source rock reservoirs or maximizing the potential from prolific mature oil and gas fields. Historically, vertical wells have used multiple diagnostic pumping techniques to establish confidence in the fracturing treatment design. These techniques include an injection/falloff test, a step-rate test, a step-down test, calibration injection, and calibration decline, among others. The pumping process is followed by collation and analysis of all the dynamic (pumping) and static (falloff) pressures to gain insight into the reservoir and rock parameters. This is similar to well-test analysis. It is an inverse solution process in which the governing model is estimated from a pressure pattern recognition behavior. Each phase of a pressure decline is dominated by a particular flow model or flow regime. As such, there is no single simplifying equation providing the answer for all cases, making it a subjective problem-solving task. After the model is recognized, simplifying solutions are used to calibrate the mechanical properties and fracturing fluid leakoff properties to achieve a calibrated treatment design.

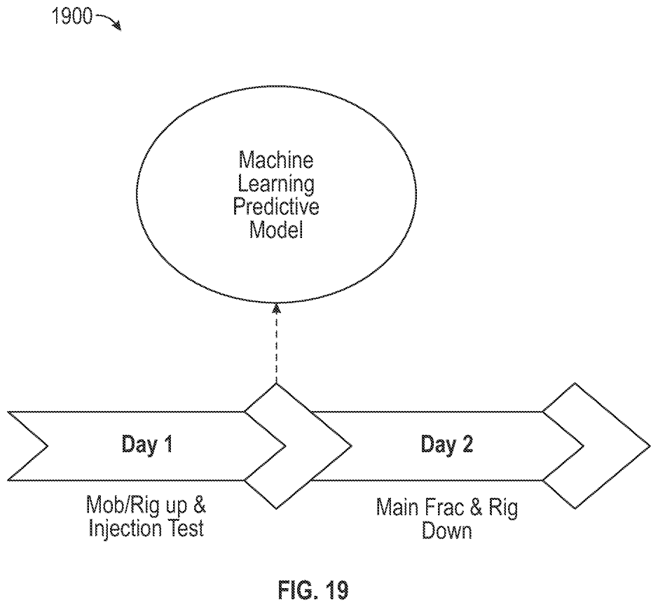

The pumping and evaluation cycles can introduce inefficiency into the operational timeline. Considering a single-stage vertical well, rigup, diagnostic pumping, model calibration, pumping the treatment, and the rig-down cycle could take 4 to 5 days. In multistage wells, considering 1 fracturing stage per day from stage 2 onwards, up to 14 days might be needed to complete a 10-stage well. An approximate linear equation for this timeline can be formulated as y=x+4, where x is the number of stages and y is the number of days required to complete. This timeline might be considered excessive in modern-day “efficiency dominated” operations in unconventional plays. FIG. 20 illustrates that the economic optimization parameter (i.e., the net present value, NPV) can be sensitive to the fracturing treatment design. For conventional reservoirs, a suboptimal design could have a sizeable impact on the oil/gas production and consequently the project economics.

The above reasoning dictates that there should, ideally, be technical input in the fracturing design in conventional plays to supplement the traditional considerations, such as avoiding screenout. Recent times have seen the advancement of automation and superior algorithms that can apply regression, classification, clustering, and dimensionality reduction techniques to existing structured data available in various applications. The embodiments described herein incorporate the requirements of the hydraulic fracturing business model to develop a balance between efficiency enablers and technical confidence in the design workflows through the spectrum of machine learning techniques.

Certain fracturing design optimization is based on the use of various numerical and analytical simulators applied for parametric studies. In addition, a few effective approaches to automate this optimization process have recently been developed, including using different mathematical approaches as well as various central objective functions that are optimized. For hydraulic fracturing design, optimization work is often centered around two surrogate objective functions. A first approach is to use NPV as the objective function that is optimized. Various mathematical techniques may be utilized to solve the optimization problem, with mixed integer linear programming (MILP) being an often-used algorithm. Another approach is to use optimization centered around production performance using supervised and/or unsupervised machine learning algorithms.

For example, one approach is to use MILP to minimize treatment costs and maximize profits (e.g., for optimum NPV) with fracture geometry (e.g., width and length) constraints. In such an approach, a comprehensive set of inputs may be used for cost calculations, including fracturing fluid and proppant costs, and profit calculations such as payout time, rate of return, and discounted return on investment for multiple scenarios, among others. Another approach is to attempt to optimize fracturing design using neural networks and design and analysis of computer experiments modeling. In such an approach, the revenue improvement analysis methodology involves hundreds of objective functions. Yet another approach is to use a different optimization domain under geospatial heterogeneity in shale reservoirs to determine the effect of fracability index (e.g., investigating the quartz dominance in rock mineralogy) on the design process. Such a geostatistics-based computational approach may be presented using a simultaneous perturbation stochastic approximation (SPSA) algorithm to maximize the NPV of shale assets.

Machine learning differs from optimization such that the latter only works with input elements to optimize over an objective whereas machine learning is used to find a solution and go one step further to predict the results for a new set of inputs. One approach to using machine learning is to use an artificial neural network (ANN) to predict production results with different design scenarios for shale development. In such an approach, the spatial-temporal database developed included reservoir, production, completion, and stimulation details. Another approach uses a similar workflow to predict and validate the production results from a digital database with, for example, more than 5,000 data points. In such an approach, multiple machine learning algorithms may be tried, and a decision tree associated with boosting algorithms may be implemented to get relatively high accuracy for the model. Yet another approach is to use a slightly different algorithm using design of experiments with Latin hypercube sampling to study the sensitivity of treatment design on production performance.

The embodiments described below propose a multivariate linear regression model and comparison with other classifier techniques such as decision tree and random forest to predict fracturing fluid efficiency in a heterogenous environment. The embodiments described below implement a robust validation workflow along with the model. As described in greater detail herein, machine learning often aims to predict or optimize fracturing treatments using production parameters as an output. The problem with this is the impact of heterogeneity (e.g., stratigraphic, reservoir development, etc.) on production. Even normalized production performance does not entirely do justice for analyzing correlations. For example, if the dataset has thousands of points, then the models will be stronger despite the heterogeneity. The embodiments described below use relatively smaller datasets, and the resultant design parameters are used as a proxy for production performance. So, in other words, the production performance is considered implicitly. The embodiments described below provide many benefits, which are described in greater detail in the following section including, but not limited to: (1) the techniques are applicable for conventional reservoirs and small to large datasets, even though for large datasets, regression models are recommended; (2) the digital database built is fast and simple, only requiring analyzed parameters from a short injection/falloff test to predict the treatment design parameters, as compared to models that include more parameters and variables, which can lead to relatively complicated models, leading to overfitting issues; and (3) a robust validation workflow may be developed using fracture geometry comparison with state-of-the-art simulations.

In development of the embodiments described herein, fracturing theory was used for dataset construction. The design ideology for a fracturing treatment has evolved over the years revolving around the same central concepts. For example, it has been determined that production performance relies on variations in the interplay between fracture length and width, depending on the reservoir quality. Low-permeability reservoirs benefit from the increasing fracture length, and conductivity is not overly crucial. In contrast, for high-permeability candidates, fracture conductivity is more significant. This leads to a qualitative design strategy to optimize the fracture geometry based on the reservoir quality evaluation. Dimensionless fracture conductivity may be used as the optimizing parameter. A more detailed modeling strategy (e.g., quantitative) can also be implemented. Pre-fracturing flowback results may be used to create a history match model, either through nodal analysis or detailed reservoir simulations. The reservoir model may then be used to test for fracture geometry sensitivity on production forecasts. An optimum strategy may be designed based on the broader asset depletion strategy.

Another important parameter to consider is the stages of fracture geometry development. For example, the pad stage creates the hydraulic geometry, the following proppant (e.g., slurry) stages fill the geometry, the stage when the proppant fills from the wellbore to the tip is called tip screenout (TSO), and what follows TSO is fracture inflation and packing (FIP). It is desirable for a higher-permeability reservoir that the FIP stage lasts longer, aiding in higher net pressure (Pₙₑₜ) evolution. For a relatively tight formation, the beginning of TSO would be optimum to conclude the treatment. In both cases, though, the optimum design is one in which at least the beginning of TSO is observed because that leaves no hydraulic geometry unpropped, and thus the maximum benefit of the treatment is achieved.

In development of the embodiments described herein, only wells that produced commercial oil and gas rates based on their respective poro-perm development were used for the database. For fluid efficiency prediction, the fluid efficiency from injection test was used to predict fluid efficiency of the calibration diagnostic test. In development of the embodiments described herein, a novel approach was used to analyze each treatment for the occurrence of TSO; none of the data where TSO did not occur were utilized. One criterion that was used was that, for a low-permeability reservoir, TSO starts towards the end of the job. The TSO should not be confused with the pressure trends associated with proppant admittance, etc. Another criterion that was used was that, for a high-permeability reservoir, a reasonable net pressure gain in the FIP stage is achieved. A TSO multiplier coefficient was calculated as a ratio of net pressure after proppant fracturing over the net pressure after calibration treatment. Screening criteria was a TSO multiplier between 1.5 and 2.0.

In this way, all suboptimal treatments were eliminated during the database construction. In the next step, fracturing fluid efficiency was calculated from the actual proppant placement instead of using the output from calibration treatment. This is because there were no strong correlations seen in the database between pad volumes and crosslinked fluid efficiency. A possible reason is because the volume of the pad stage is usually different from calibration, causing variations in hydraulic propagation dynamics. Also, the extra height growth can completely change the dynamic leakoff evolution during the treatment. Even though these methodologies caused the database size to be smaller, and added intensive analyses input in the preprocessing stage, the digital database was a strong proxy considering optimal production enhancement design.

Example concepts and calculations of pad ratio from treatment parameters will now be discussed. During the fracturing treatment, the fluid efficiency (n) history evolves continuously. The FE decreases as the fracture propagates in length. After the length ceases to grow, the area to leakoff stops increasing. Fracture is in tip screenout (TSO) mode at this point; the fracture width starts increasing with the net pressure causing fracture inflation (FIP stage). The amount of linear net pressure increase before the fracture width stops inflating depends on the fracture compliance, which depends on the rock stiffness (Young's modulus) when the height is constant. It can be inferred that the demarcating instances in the treatment at which these stages initiate can yield critical information about the dynamics of fluid leakoff and optimum fracture geometry.

The theory of fluid efficiency calculations demonstrates that time can be used as a proxy parameter for fracture volume (constant injection rate). Analyzing the proppant placement, flags are created such as the start of pad step, start of proppant, and start of TSO. The times recorded at the flags are then used for FE and pad calculations. The ratio of pad volume over slurry volume when the proppant reaches the tip of the fracture can be used to calculate the dirty pad ratio. Efficiency can then be calculated from the pad ratio. Below is a brief mathematical description of the analysis.

In Eq. 1, t_{pad} is the time at which pad fluid reached perforation, tₚᵣₒₚ is the time at which the first proppant step reached perforation, and tₜₛₒ is the time at which TSO mode initiated based on the net pressure trend. The pad ratio (PR) for the main fracturing treatment is:

$$PR = \frac{{t}_{p r o p} - {t}_{p a d}}{{t}_{tso} - {t}_{p a d}} \qquad ( Eq . 1 )$$

Main treatment fluid efficiency (η_{mf}) at the point of TSO is:

$${η}_{m f} = \frac{1 - P R}{1 + P R} \qquad ( Eq . 2 )$$

The derived PR in Eq. 2 can be used for the non-TSO design. Using the above calculated η, more aggressive TSO pad ratios can be calculated. The aggressive design can be quantitatively defined through the term TSO multiplier (a) calculated from end of job (EOJ) net pressures generated:

$$a = \frac{Treatment EOJ Pnet}{Calibration EOJ Pnet} \qquad ( Eq . 3 )$$

Using that same efficiency, various TSO-mode calculations can be done for PR to achieve the required TSO multiplier coefficients. The maximum recommended (very aggressive) TSO multiplier is 2.5, and anything beyond that would potentially lead to a fully packed fracture reaching completion pressure limits depending on the fracture compliance). This pressure max-out should not be confused with a near-wellbore screenout, which is related to proppant admittance. Fracturing design optimization can be done through dimensionless productivity (J_{d}) or NPV analysis. But generally, the optimum design should consider a TSO multiplier of 2.0 to benefit the fracture conductivity. It should be noted though that achieving a TSO multiplier of 2.0 using 20/40 mesh proppant is not the same as achieving the same with a 12/18 mesh proppant. Table 1 below gives some logical calculations in increasing order of design aggressiveness. The net pressure gain over the calibration treatment is calculated based on the formula:

$$Pnet\_f = Pnet\_c + \frac{1 - {η}_{m f}}{( {η}_{mf} * PR * ( 1 + {η}_{mf} ) ) - 1 / {η}_{mf} ) * Pnet\_c} \qquad ( Eq . 4 )$$

Where Pnet_f=net pressure after fracturing treatment and Pnet_c=net pressure after calibration treatment.

TABLE 1
Pad ratio scenarios for TSO design levels for 50% fluid
efficiency (η_{mf}); Pnet_c = 500 psi

| | | Pad percent | | Final Pnet |
|---|---|---|---|---|
| | | [%] | TSO | [psi] |
| | PR Formula | η_{mf=0.5} | Multiplier | Pnet_c = 500 psi |
| 1. | (1 − η_{mf})/(1 + η_{mf}) | 33.33 | 1.00 | 500 |
| 2. | (1 − η_{mf})/[(1 + η_{mf}) * | 26.66 | 1.50 | 750 |
| | (1 + η_{mf}/2)] | | | |
| 3. | (1 − η_{mf})² | 25.00 | 1.66 | 830 |
| 4. | (1 − η_{mf})/(1 + η_{mf})² | 22.22 | 2.00 | 1000 |
| 5. | (1 − η_{mf})²/(1 + η_{mf}) | 16.67 | 3.00 | 1500 |
| 6. | 1/2 * (1 − η_{mf})/ | 16.67 | 3.00 | 1500 |
| | (1 + η_{mf}) | | | |
| 7. | (1 − η_{mf})²/(1 + η_{mf})² | 11.11 | 5.00 | 2500 |

The calculations in Table 1 can be an important resource as a guide for treatment design engineers, especially when width optimization is the primary treatment objective. However, it must be understood that the calculations in Table 1 are valid under some assumptions based on the classical theory of fluid leakoff:
At the beginning of TSO, the PR is as per calculation 1 in Table 1.
After TSO, fracture area (length×height) is constant and there is no additional leakoff.
After TSO, all slurry injection and net pressure generated contribute to fracture width development.

The embodiments described herein use a machine learning solution approach. When the target (e.g., predicted) datasets consist of a target vector/variable with either real continuous values or category labels, the problem falls under the supervised learning (SL) category. The SL problem is formulated by a target function \hat{ƒ}: X→Y approximating ƒ given a learning sample Sₙ={(xₙ, yₙ)}, where xₙ∈X and yₙ∈Y with yᵢ=ƒ(xᵢ). SL is further categorized into regression and classification techniques. The other major branch is termed unsupervised learning (UL), wherein targets do not exist, and the workflow attempts pattern recognition within the data. The widely used algorithms for UL are clustering and dimensionality reduction (t-SNE). Because the construct of the digital database allowed research with categorical labels, SL was chosen for development of the embodiments described herein.

In development of the embodiments described herein, five machine learning algorithms using regression and classification techniques were chosen: (1) support vector machine (SVM), (2) decision tree (DT), (3) random forest (RF), (4) multinomial, and (5) extreme gradient boost (XGBoost). In addition, in certain embodiments, other types of bagging, boosting, regression, classification, and/or supervised machine learning predictive models or algorithms may be utilized.

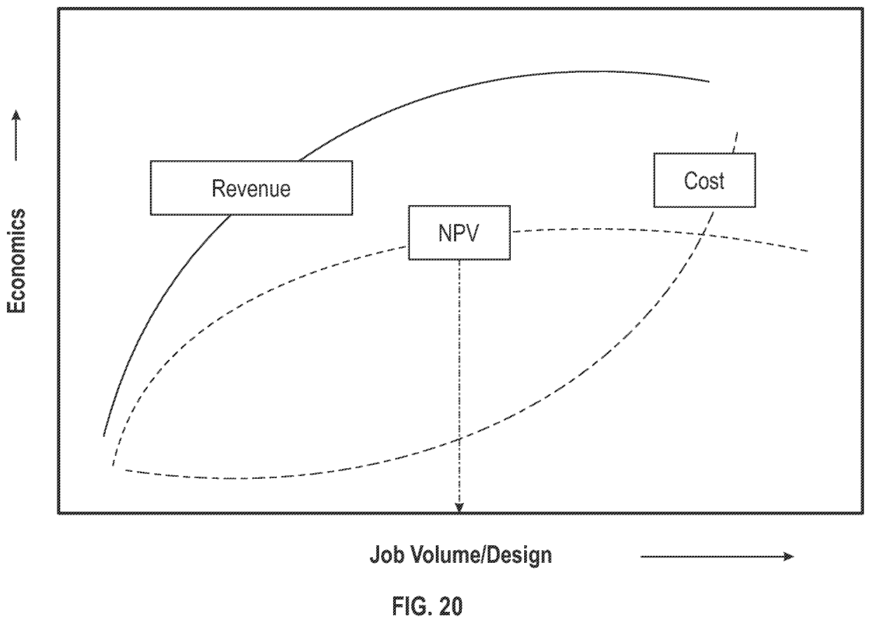

FIG. 21 illustrates an example an exploratory and confirmatory data analysis framework 2100, which was used for comparative research of the machine learning techniques described above as they apply to the embodiments described herein. As illustrated, the data analysis framework 2100 includes data construction and preprocessing 2102, which includes data collection, data cleaning, data transformation, and data reduction, among other things. In addition, based on the data construction and preprocessing 2102, the data analysis framework 2100 includes developing a machine learning predictive model 2104, which includes variable selection, building candidate models, and model validation and selection, among other things. In addition, the data analysis framework 2100 includes implementation of the developed machine learning model, which includes interpreting the machine learning model, communicating insight of the machine learning model, documenting the process for reproducibility of the machine learning model, monitoring and maintaining of the machine learning model, among other things. The complete cycle from starting with a raw data set to implementing the machine learning predictive model in the field was conducted, and the results were verified through a stimulation domain-oriented workflow.

The data analysis framework 2100 of FIG. 21 was then applied to develop a specific workflow to compare different machine learning algorithms and define any limiting factors. FIG. 22 illustrates a workflow 2200 for developing the machine learning models described with reference to FIG. 21, which can be looped each time for different case runs. As described in greater detail below, a total of 15 cases were created based on the machine learning algorithm type and number of classes. As illustrated in FIG. 22, the workflow 2200 includes data splitting 2202 where, for example, the data sets may be split into training sets and validation sets, as described in greater detail herein. Then, the workflow 2200 includes starting the learning process 2204, which then leads to the resulting machine learning algorithms starting and/or proceeding to next steps 2206, as described in greater detail herein. Then, the workflow 2200 includes tuning of the machine learning models 2208 via, for example, a hyperparameter tuning loop, as described in greater detail herein. Then, a sensitivity/specificity study 2210 may be performed on the tuned machine learning models, and a confusion matrix 2212 and a performance matrix 2214 may be employed to assess the performance of the machine learning models, as described in greater detail herein. Once all of the loops for the different case runs have completed, the workflow 2200 may end by compiling and evaluating all of the machine learning models 2216.

The data construction and preprocessing will now be described. To build any machine learning model, there generally needs to be historical data that can be used as input features and a clear set of output features to be predicted. As such, one of first steps in the development of the embodiments described herein was to build the dataset in line with fracturing domain expertise. A main objective was to predict the fluid efficiency, total proppant amount, and maximum proppant concentration for heterogeneous reservoir environments. All the data were gathered and cleaned based on criteria detailed earlier, thus eliminating jobs without TSO, nonproductive jobs, and jobs with any operational issues that could introduce inherent errors into the model. Next, a correlation study was performed for the regression algorithms (e.g., SVM and multinomial) to ensure the dataset is sound based on derived causality, and to minimize the highly correlated features that could affect the output. The classification algorithms (e.g., DT, RF, and XGBoost) automatically account for the feature correlations, so this step was skipped.

The injection/falloff test yields some useful parameters from the analysis of the declining pressure transient. Eight input parameters were chosen for correlation, including shut-in pressure (ISIP), closure pressure, P_star (e.g., initial slope of the pressure decline curve), reservoir pressure, treated water fluid efficiency, transmissibility, Gc (e.g., G-function time at closure), and ClCr (e.g., leakoff ratio of pressure drop in reservoir and total pressure drop, which gives the dominant leakoff mechanism). Five output parameters were also investigated, including total proppant, maximum prop concentration, pad volume, clean pad ratio, and crosslinked fluid efficiency.

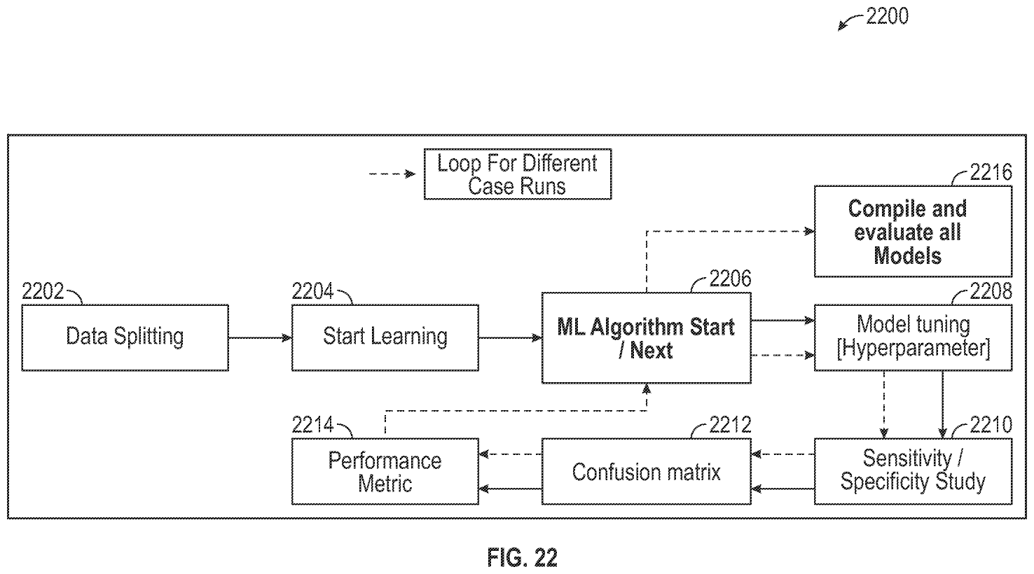

FIG. 23 illustrates the preprocessing I/O parameter correlation matrix of all 13 parameters. Several observations confirmed intuitive relations between parameters. Observations that confirm the strength and/or validity of dataset construction based on the fracturing domain understanding include the following:
Higher shut-in pressure implies higher closure pressure because both parameters are a measure of the rock mechanical stress.
Higher shut-in and closure pressures also have:
   A strong positive correlation with reservoir pressure because it is mathematically correlated with stress.
   Negative correlation with transmissibility and maximum prop concentration because highly stressed rocks usually show lower flow capacity and lower proppant admittance.
Reservoir pressure shows a strong correlation with fluid efficiency/leakoff (e.g., both water and crosslinked fluid) and transmissibility.
G_{c} shows a strong correlation with fluid efficiency because they are mathematically correlated.
Total proppant depends on proppant concentration, which is expected.
Pad volume shows a strong negative correlation with maximum prop concentration.

After the preliminary correlation exercise, the classes were chosen for each output based on the range boundaries: (1) fluid efficiency was categorized into three classes (i.e., low, medium, and high), and (2) total proppant and maximum proppant concentration were subject to sensitivity for a number of classes to enhance the accuracy. Cases with six, five, and four classes were investigated. The details of the class boundaries are given in Table 2 below, which shows various cases investigated for total proppant and maximum proppant concentration sensitivity. It should be noted that all of the data illustrated in Table 2 were generated from synthetic and/or published data.

TABLE 2
Class boundary ranges for proppant amounts and concentrations

| | Six-Class Case | | Five-Class Case | | Four-Class Case | |
|---|---|---|---|---|---|---|
| | Total Proppant (lb) | | Total Proppant (lb) | | Total Proppant (lb) | |
| Class | Min | Max | Min | Max | Min | Max |
| 1 | 81,000 | 124,667 | 81,000 | 133,400 | 81,000 | 146,500 |
| 2 | 124,667 | 168,333 | 133,400 | 185,800 | 146,500 | 212,000 |
| 3 | 168,333 | 212,000 | 185,800 | 238,200 | 212,000 | 277,500 |
| 4 | 212,000 | 255,667 | 238,200 | 290,600 | 277,500 | 343,000 |
| 5 | 255,667 | 299,333 | 290,600 | 343,000 | | |
| 6 | 299,333 | 343,000 | | | | |
| | Max Prop Con (PPA) | | Max Prop Con (PPA) | | Max Prop Con (PPA) | |
| Class | Min | Max | Min | Max | Min | Max |
| 1 | 2.00 | 3.50 | 2.00 | 3.80 | 2.00 | 4.25 |
| 2 | 3.50 | 5.00 | 3.80 | 5.60 | 4.25 | 6.50 |
| 3 | 5.00 | 6.50 | 5.60 | 7.40 | 6.50 | 8.75 |
| 4 | 6.50 | 8.00 | 7.40 | 9.20 | 8.75 | 11.00 |
| 5 | 8.00 | 9.50 | 9.20 | 11.00 | | |
| 6 | 9.50 | 11.00 | | | | |

The accuracy of a certain ML model depends on the size, nature, and preprocessing of the dataset. A primary investigative objective was to demonstrate the effect of different algorithm processing applied to the same dataset. The data source is pooled based on diagnostic treatment parameters and the design parameters. After the data cleaning and ingestion, the next step is splitting the data set into train-validation-test sets. In our work, we reserve (e.g., hold out) 20% of the data for evaluation of the final model. A five-fold cross-validation was used. In our generalized model, based on the wells (e.g., rows) available, the regression or classification models are used. Based on the relatively small dataset, five predictive algorithms were chosen, as described above, based on the final data structure and size. The training data points were used to train the model to make accurate predictions for the outputs. The ratio of training-to-testing data ranged between 80:20 and 70:30 for different cases. After preprocessing and eliminating the data, a total of 125 remaining well datapoints were split between training and testing sets accordingly.

Moreover, the split method helped identify high bias (e.g., underfitting) or high variance (e.g., overfitting). For instance, if the machine learning predictive model has relatively high (but consistent) error in both training and testing data sets, it indicates an underfitting model in both sets and has a high bias. On the other hand, if the model gives relatively low error rate in the training set but relatively high error rate in holdout, that is an indication of high variance (e.g., overfitting) because the model could not generalize to the holdout set of data. Once sampling was defined, machine learning models were introduced to the training data to learn and predict the three dependent variables separately. Then, the model was subjected to validation through the testing data. Model-tuning was conducted to have a relatively low bias and relatively low variability to reduce the bias-variance tradeoff and produce consistently accurate results for the training and testing datasets.

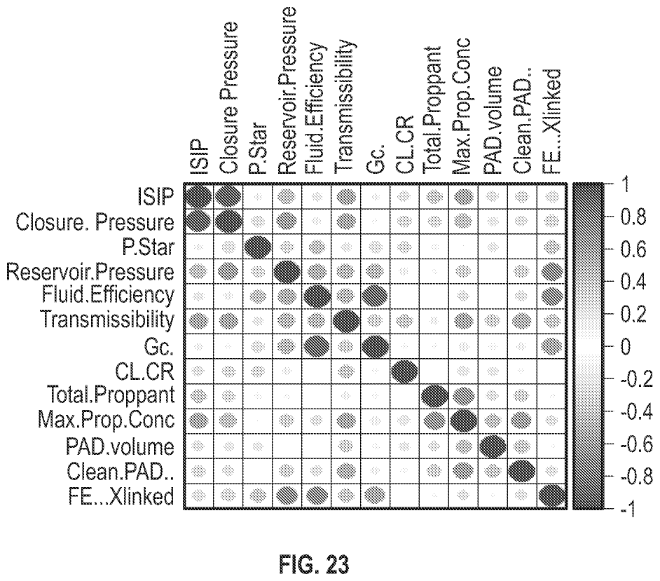

FIG. 24 illustrates a predictive model workflow 2400 for digital database construction and machine learning implementation to predict fracturing design treatment parameters. As illustrated in FIG. 24, in certain embodiments, the predictive model workflow 2400 may access a data source 2402 (e.g., digital database) that includes data such as fracturing design parameters 2404, injection/falloff parameters 2406, step rate/step down test parameters 2408, calibration injection data 2410, and calibration decline data 2412, among other data. The data stored in the data source 2402 (e.g., digital database) may be transformed into particular features using feature engineering 2414.

As described in greater detail herein, in certain embodiments, the output of the feature engineering 2414 may be divided into various sets of data including, but not limited to: (1) a training data set 2416 that is used to optimized both regressor machine learning algorithms 2418 and classifier machine learning algorithms 2420, which may lead to a k-fold cross-validation 2422 (e.g., where k=5 in the illustrated embodiment) where the training data set 2416 is split into k subsets (e.g., folds) where each fold is used as a training set at some point; (2) a validation data set 2424 that is used to validate the k-fold cross-validation 2422 of the optimized machine learning algorithms 2418, 2420; and (3) a test (e.g., hold-out) data set 2426 that is used during final model validation 2428 of the k-fold cross-validation 2422 of the optimized machine learning algorithms 2418, 2420, which leads to fracturing treatment design parameters 2430. As such, the training data set 2416 and the validation data set 2424 are used for model training 2432 (e.g., of the optimized machine learning algorithms 2418, 2420), whereas the test (e.g., hold-out) data set 2426 is used for final model validation 2428 of the k-fold cross-validation 2422 of the optimized machine learning algorithms 2418, 2420.

As illustrated in FIG. 24, in certain embodiments, the model training 2432 may include hyperparameter tuning 2434 back from the k-fold cross-validation 2422 to the optimized machine learning algorithms 2418, 2420 to control the learning process of the optimized machine learning algorithms 2418, 2420. In addition, in certain embodiments, the optimized machine learning algorithms 2418, 2420 may be used to determine certain feature importance 2436, which may be leveraged during the validation process of the k-fold cross-validation 2422 of the optimized machine learning algorithms 2418, 2420.

In addition, in certain embodiments, the operational parameters may be further used to fine-tune the pre-trained machine learning algorithms 2418, 2420 via transfer learning. In addition, in certain embodiments, the operational parameters may be obtained from one or more multiphysics simulations, as described in greater detail herein. In addition, in certain embodiments, the operational parameters may be obtained by training on a combination of data obtained from one or more multiphysics simulations and operational data specific to the field of the well or an analogous field, as described in greater detail herein.

The hyperparameter tuning loop utilizes a trial-and-error process to tune the model and rerun the algorithm. The model performance can be maximized by selecting the optimum set of hyperparameters. Default parameters were used for all five algorithms on initialization, followed by fine-tuning. Based on a gross comparison of the algorithms, XGBoost chosen as the default. The XGBoost was then adjusted by running a permutation and combination of different tree boosting parameters to identify the combination with highest accuracy. Below are the hyperparameters used:
nrounds/n_estimators [1500]. This controls the maximum number of iterations or trees to grow.
nfold/n_splits [5]. This is a cross-validation technique that divides the set of observations into k equal folds and treats the first fold as validation set to fit the remaining (k−1) folds.
Eta/learning rate [0.1]. This is used to shrink the step size during update to prevent overfitting. After each boosting step, new feature weights are calculated, and eta shrinks the feature weights to make the boosting process more conservative and optimize the fitting.
max_depth [3]. This is the maximum depth of a tree. Increasing this value makes the model more complex and likely to overfit.

The outer testing loop is then used to evaluate the model, wherein the output will be hidden from the holdout set 2426 and the model intelligence in terms of predictions is tested. After adequate performance evaluation is conducted, the final model is saved and selected to initiate the implementation stage.

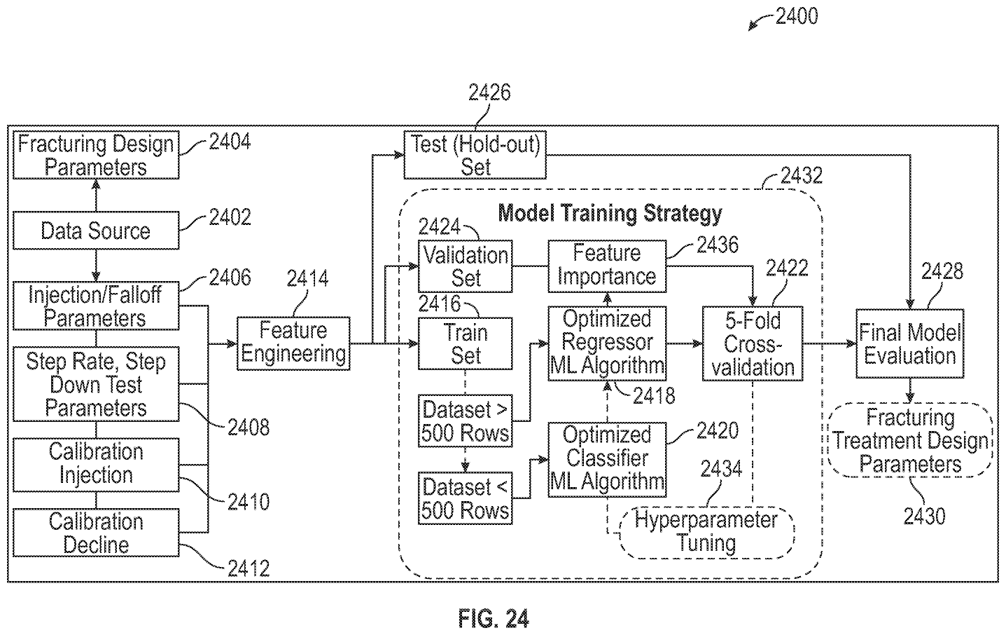

Because the dataset was small and the dependents were categorized in classes, more advanced performance evaluation beyond R² and root-mean-square-error (RMSE) was used. The evaluation phase utilized the confusion matrix for each model. A confusion matrix is a performance matrix for any machine learning model, where the output of the model can be two or more classes. FIG. 25 illustrates a description of a confusion matrix with the rows representing the predicted class and columns representing the actual class.

Four performance metrics were derived from the confusion matrix to evaluate the strength of the model; accuracy, precision, recall, and the F measure are used to validate the predictive model. Accuracy of the model is calculated as the number of correct predictions divided by the total number of elements in the dataset.

$$Accuracy = \frac{T P + T N}{T P + T N + F N + F P}$$

Accuracy is not always the preferred performance metric, especially when the output has some classes occurring more frequently than others. In such a case, much better performance measures exist in the form of precision and recall of the model or a single metric that combines the weighted effect of these two, called the F1 score, which is the harmonic mean of precision and recall. The highest possible value of an F1 score is one (100%), which indicates perfect precision and recall, and the lowest F1 score is zero (0%).

$$F 1 = \frac{2 * precision * recall}{precision + recall} , where Precision = \frac{T P}{T P + F P} and$$

$$Recall = \frac{T P}{T P + F N}$$

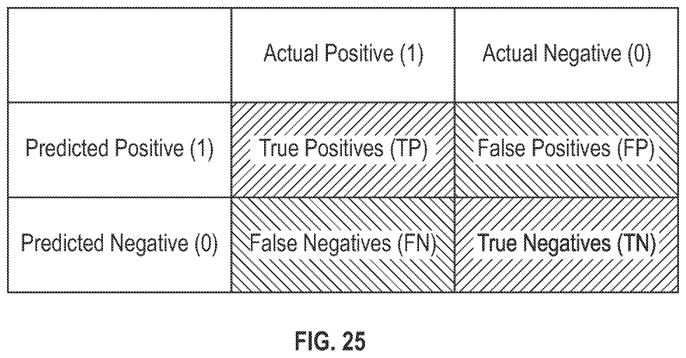

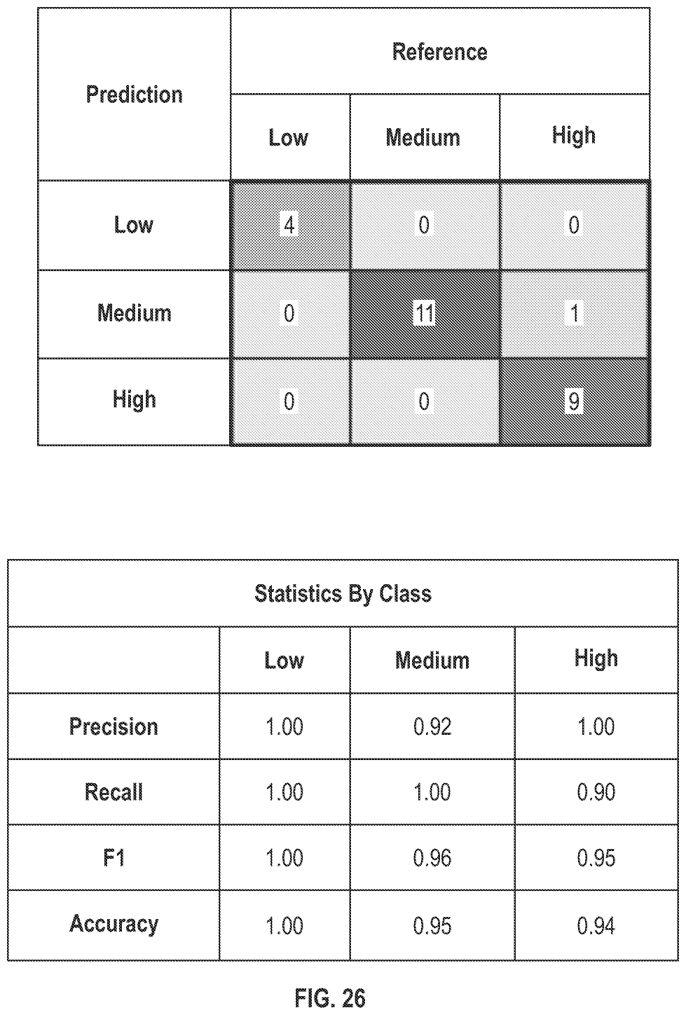

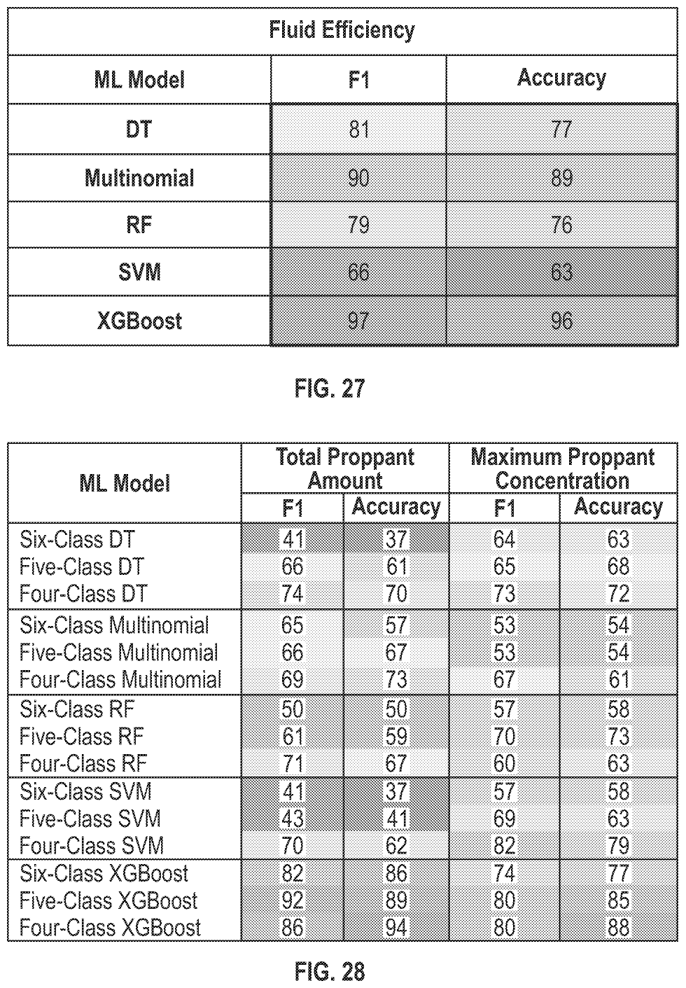

For each model run, a confusion matrix and performance statistics were generated. FIG. 26 illustrates the confusion matrix (top table) and performance metrics (bottom table) for the fluid efficiency output parameter using the XGBoost model, which showed the best results based on the accuracy and F1 score. A total of 25 wells was used to test the model performance (e.g., 100 wells were used for training). As can be seen, 24 wells were correctly classified, and only one well was misclassified. The accuracy and F1 statistics for the tuned holdout set showed high accuracy because of three classes only. The accuracy was lower and realistic for the other parameter output test cases with more classes. A summary of the results with all models and classification sensitivity is illustrated in FIG. 27, and a summary of results with all models and classification sensitivity specifically related to total proppant amount and maximum proppant concentration is illustrated in FIG. 28, both of which are color-coded in order of increasing accuracy from red (e.g., low accuracy) to yellow (e.g., medium accuracy) to green (e.g., high accuracy). It should be noted that all of the data illustrated in FIGS. 23 and 26-28 were generated from synthetic and/or published data.

The strength of a machine learning predictive model depends on the combination of the number of data points and complexity of the model. In general, model tuning was conducted carefully to ensure low variance (e.g., overfitting) on the training set to account for the relatively low amount of data used. Regardless, a comprehensive workflow and approach for database construction was established. An advantage of using a smaller dataset is the careful cleaning and processing of the database that is possible; the smaller number of inputs allowed for consistency in analysis where subjectivity can be eliminated. Thousands of datapoints could be subject to the competency and experience of the personnel entering the data. Also, not-a-number data (NaNs) were removed from the database completely because some of the algorithms used cannot handle NaNs. Imputation techniques (e.g., mean, median, regression, collaborative filtering, etc.) could be used as a resolution, however it was assumed that it is best to avoid synthetic data for model building.

Certain highlights, discussion, and interpretation were determined based on the results achieved using multiple machine learning techniques described above:
Overall, XGBoost shows the best accuracy for a high to low number of classes. Boosting algorithms were expected to perform better because they focus on examples with high error at each iteration.
Six-class or five-class XGBoost seemed to perform the best. A higher number of classes retains the granularity of the predictions, which is essential for design precision.
The output based on class boundaries provides a flexible range to choose the design within 40,000 to 50,000 lbm of proppant totals and 0.8 lbm/galUS of maximum proppant concentration.
Generally, the six-class case showed low accuracy for all algorithms except XGBoost. This could be purely due to the amount of data used and does not imply that the other algorithms are inferior.
Generally, lowering the number of classes enhances the model accuracy, but loses the prediction granularity as a tradeoff.
Multinomial logistic regression showed consistent accuracy among different classes compared to the tree classifiers, wherein the accuracy contrast was very high for different number of classes.
SVM showed poor prediction accuracy, which was expected because SVMs perform better with binary classifications. Another possible explanation could be the relatively high performance of SVM for more homogenous or hierarchical model predictions such as text, audio, and image recognition.
RF was expected to perform better predictions. However, the weaker predictions may simply be the result of the amount of data used. With a lower amount of data, RF is not recommended. However, it could be predicted that XGBoost would perform better on their dataset than RF.
Another implication is the limited functionality of tree-based algorithms for step function decision boundaries. The tree-based algorithms performed well for the fluid efficiency, but the other two outputs with stair-step classes performed poorly.

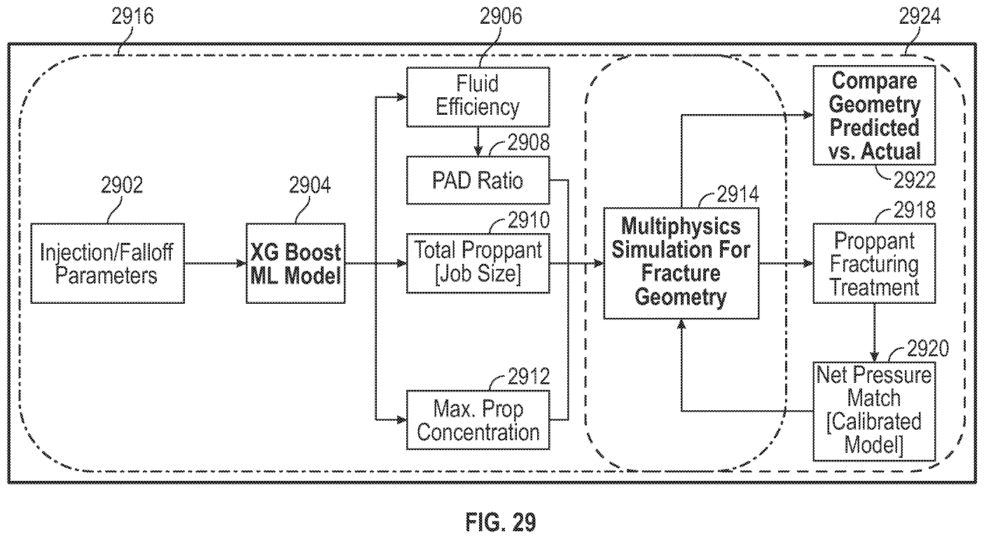

A robust validation workflow was developed for the fluid efficiency prediction model. After the machine learning predictive model converged to accurate predictions, five wells in heterogeneous plays were selected to employ the machine learning predictive model and use the design output. The field validation of the model prediction centered around fracture geometry and pressures. So, a comparison was performed between the pre-fracture predicted model and the post-fracture pressure-match-calibrated model. FIG. 29 illustrates the machine learning predictive model design and validation workflow 2900 that was utilized. The workflow 2900 provides an integrated forward/inverse problem framework to first predict the fracturing design parameters using the machine learning predictive model (e.g., forward), and then to predict fracture geometry using advanced simulation techniques (e.g., inverse). In particular, as illustrated, injection/falloff parameters 2902 may be used as inputs to the XGBoost machine learning predictive model 2904 described above, which outputs fluid efficiency 2906, which may be used to determine PAD ratio 2908, total proppant (e.g., job size) 2910, and maximum proppant concentration 2912, which in turn may be used as inputs into a multiphysics simulation model 2914 for fracture geometry as the design stage 2916. Then, the multiphysics simulation model 2914 outputs a proppant fracturing treatment 2918, which may be used to find a post-fracturing net pressure match (e.g., calibrated model) 2920, which may in turn be fed back into the multiphysics simulation model 2914 as another input. Ultimately, the multiphysics simulation model 2914 may be used to compare the predicted fracture geometry to the actual fracture geometry 2922. As illustrated, the outputs of the multiphysics simulation model 2914 are part of the validation stage 2924.

In addition, in certain embodiments, the operational parameters may be further used to fine-tune the pre-trained machine learning predictive model via transfer learning. In addition, in certain embodiments, the operational parameters may be obtained from one or more multiphysics simulations 2914. In addition, in certain embodiments, the operational parameters may be obtained by training on a combination of data obtained from one or more multiphysics simulations 2914 and operational data specific to the field of the well or an analogous field.

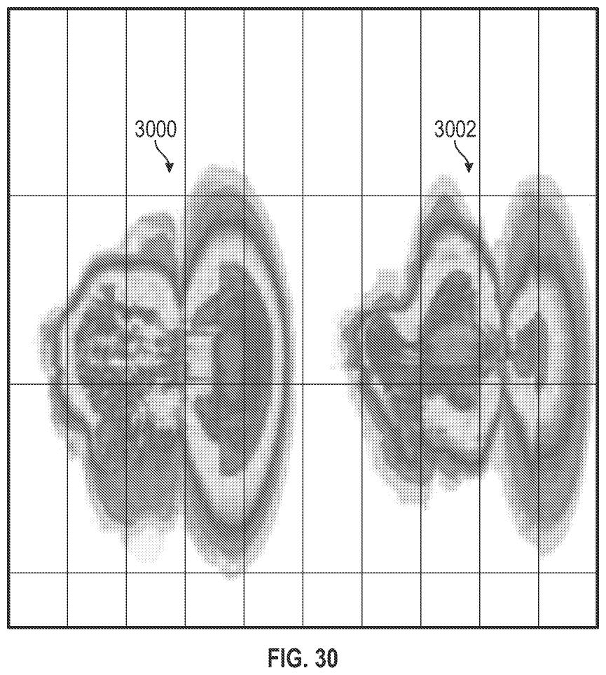

In one of the five sample wells, an injection/falloff test with water was pumped, and the proppant fracturing treatment was redesigned based on the prediction of the model using only the analyzed parameters. The simulations were run using a fine grid resolution multiphysics planar3D (PL3D) model to evaluate thoroughly. However, in other embodiments, other commercially available multiphysics models (e.g., a pseudo3D model (P3D), a Perkins-Kern-Nordgren (PKN) model, a Kristianovich-Geertsma-de Klerk (KGD) model, or some combination thereof) may be used. This simulator accounted for the influence of materials distribution on fracture propagation. It calculated fracture conductivity distribution based on fracture hydrodynamics and in-situ kinetics, which accounts for superior slurry transport modeling. FIG. 30 illustrates a comparative fracture geometry from the outputs of the XGBoost model (e.g., the machine learning predictive model prediction fracture geometry) 3000 and the post-fracturing net pressure match fracture geometry 3002 after the treatment was pumped

The workflow 2900 was adopted for all five wells in the pilot validation stage 2924, and all of the treatments were within 4-8% variation with the simulated pressures, fracture height, and fracture length. In addition, all of the wells showed dimensionless fracture conductivity greater than 1.6; none of the jobs experienced near-wellbore screenout. Most importantly, none of the simulated cases showed more than 3-5% unpropped fracture area. The production performance was compared with the close representative offsets through normalized productivity indices calculated from the post-fracturing flowback after the cleanup phase concluded. The results showed an average production enhancement of 17%, with only one well 4% lower than the offset. The validation summary indicated that the predicted design provided strong technical confidence for placement and production performance, hence supporting the vast implementation of the model in various reservoir environments.

The digital database described herein may be populated with additional data from data libraries (e.g., open-source data libraries) to encompass various reservoirs and increase the model fidelity for global usage. In addition, additional correlations between pressure analysis of the pump down for perforating operations (PDP) and the treatment parameters may be established to further optimize the process and develop insights for horizontal plug-and-perf wells. Similar models may also be created for newly discovered unconventional plays in the Far East and Middle East where North American practices have not fully worked in these relatively challenging unconventional fields. Those models may focus more on predicting and optimizing well placement, stage spacing, fluid volumes per lateral, and proppant masses per lateral to maximize oil and gas production rates.

In developing the embodiments described herein, it is evident from multiple studies that modern boosting algorithms may be used more frequently to enhance model accuracy in the domain of data science. The enhanced database described herein may be used to compare the boosting algorithms primarily, including adaptive boost (AdaBoost), CatBoost, and light gradient boosting machine (LGBM) with the current XGBoost optimized model. Data analytics and machine learning-driven modeling from various branches of well engineering and reservoir management workflows can be integrated into the frameworks described herein to tailor the decision making and substantially remove subjectivity.

In summary, many conclusions have been made during development of the embodiments described herein. These include:
A comparative machine learning research framework and workflow was used to evaluate the performance of five popular machine learning algorithms (i.e., support vector machine, random forest, decision tree, multinomial, and XGBoost) to solve the forward problem of predicting treatment design parameters based only on injection/falloff analysis.
Established theoretical concepts from the fracturing domain were utilized in the data ingestion, data cleaning, and feature selection exercise, making it an integrated machine learning domain implementation.
The XGBoost machine learning predictive model showed relatively high accuracy and F1 scores (80 to 90%) for the fracturing design parameters, making it a robust design tool for heterogeneous reservoirs.
As a second part, an inverse problem is solved to predict the fracture treatment geometry based on machine learning predictive model output. A robust field validation workflow is based on advanced multiphysics fracturing simulations.
The usage of the model aided in the enhancement of operational efficiency by 60-65%. The operational timeline equation changed from y=x+4 to y=0.67x+2.34 where x is the number of stages and y is the days required to complete.
The innovative design approach described herein was analyzed for four areas of improvement and showed the following advantages, among others: reduction in polymer consumption by 30%, reduction of the flowback time by 25%, reduction of water usage by 30%, and enhanced operational efficiency by 60-65%.
The utilization of data analytics and machine learning for hydraulic fracturing projects resulted in enhanced economics for the operator, as well as for the service company by reducing CAPEX and OPEX and increasing hydrocarbon recovery and revenue.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method, comprising:
receiving data relating to an injection/falloff test performed in a well in fluid communication with a subterranean reservoir;
determining operational parameters of a hydraulic fracturing operation using at least a portion of the data;
applying the operational parameters to a pre-trained machine learning predictive model to determine an optimal set of control parameters; and
issuing one or more control commands relating to the optimal set of control parameters to optimize the hydraulic fracturing operation on the subterranean reservoir.

2. The method of claim 1, wherein the operational parameters are further used to fine-tune the pre-trained machine learning predictive model via transfer learning.

3. The method of claim 1, wherein the operational parameters are obtained from one or more multiphysics simulation models.

4. The method of claim 1, wherein the operational parameters are obtained by training on a combination of data obtained from one or more multiphysics simulation models and operational data specific to a field of the well or an analogous field.

5. The method of claim 1, wherein the machine learning predictive model comprises an extreme gradient boost (XGBoost) machine learning predictive model.

6. The method of claim 1, comprising training the machine learning predictive model using data relating to injection/falloff parameters as inputs, and data relating to fluid efficiency, total proppant used, and maximum proppant concentration as outputs.

7. The method of claim 6, comprising:
using the data relating to the fluid efficiency to determine data relating to a pad ratio; and
validating the machine learning predictive model using a multiphysics simulation model with the data relating to the pad ratio, the total proppant used, and the maximum proppant concentration as inputs.

8. The method of claim 7, wherein validating the machine learning predictive model comprises:
generating data relating to a proppant fracturing treatment as an output from the multiphysics simulation model; and
using the proppant fracturing treatment to calibrate the machine learning predictive model based at least in part on a post-fracturing net pressure match.

9. The method of claim 1, wherein the one or more control commands are issued to a controller that is operatively coupled to one or more pieces of hydraulic fracturing equipment.

10. A system, comprising:
one or more processors;
memory accessible to the processor;
processor-executable instructions stored in the memory and executable by the one or more processors to instruct the system to:
receive data relating to an injection/falloff test performed in a well in fluid communication with a subterranean reservoir;
determine operational parameters of a hydraulic fracturing operation using at least a portion of the data;
apply the operational parameters to a pre-trained machine learning predictive model to determine an optimal set of control parameters; and
issue one or more control commands relating to the optimal set of control parameters to optimize the hydraulic fracturing operation on the subterranean reservoir.

11. The system of claim 10, wherein the operational parameters are further used to fine-tune the pre-trained machine learning predictive model via transfer learning.

12. The system of claim 10, wherein the operational parameters are obtained from one or more multiphysics simulation models.

13. The system of claim 10, wherein the operational parameters are obtained by training on a combination of data obtained from one or more multiphysics simulation models and operational data specific to a field of the well or an analogous field.

14. The system of claim 10, wherein the machine learning predictive model comprises an extreme gradient boost (XGBoost) machine learning predictive model.

15. The system of claim 10, wherein the processor-executable instructions are executable by the one or more processors to instruct the system to train the machine learning predictive model using data relating to injection/falloff parameters as inputs, and data relating to fluid efficiency, total proppant used, and maximum proppant concentration as outputs.

16. The system of claim 15, wherein the processor-executable instructions are executable by the one or more processors to instruct the system to:
use the data relating to the fluid efficiency to determine data relating to a pad ratio; and
validate the machine learning predictive model using a multiphysics simulation model with the data relating to the pad ratio, the total proppant used, and the maximum proppant concentration as inputs.

17. The system of claim 16, wherein the processor-executable instructions are executable by the one or more processors to instruct the system to:
generate data relating to a proppant fracturing treatment as an output from the multiphysics simulation model; and
use the proppant fracturing treatment to calibrate the machine learning predictive model based at least in part on a post-fracturing net pressure match.

18. The system of claim 10, wherein the one or more control commands are issued to a controller that is operatively coupled to one or more pieces of hydraulic fracturing equipment.

19. A tangible, non-transitory computer-readable memory media storing processor-executable instructions that, when executed by one or more processors, cause the one or more processors to:
receive data relating to an injection/falloff test performed in a well in fluid communication with a subterranean reservoir;
determine operational parameters of a hydraulic fracturing operation using at least a portion of the data;
apply the operational parameters to a pre-trained machine learning predictive model to determine an optimal set of control parameters; and
issue one or more control commands relating to the optimal set of control parameters to optimize the hydraulic fracturing operation on the subterranean reservoir.

20. The tangible, non-transitory computer-readable memory media of claim 19, wherein the operational parameters are further used to fine-tune the pre-trained machine learning predictive model via transfer learning.
